(19) United States
(12) Patent Application Publication
(10) Pub. No.: US 2023/0018960 A1
(43) Pub. Date: Jan. 19, 2023

(54) SYSTEMS AND METHODS OF ASSIGNING A CLASSIFICATION TO A STATE OR CONDITION OF AN EVALUATION TARGET

(71) Applicant: SparkCognition, Inc., Austin, TX (US)

(72) Inventor: Alexandre Ardel, Austin, TX (US)

(21) Appl. No.: 17/812,230

(22) Filed: Jul. 13, 2022

Related U.S. Application Data
(60) Provisional application No. 63/222,532, filed on Jul. 16, 2021.

(51) Int. Cl. G06N 3/04; G06N 3/08

(52) U.S. Cl. CPC G06N 3/0436; G06N 3/08

(57) ABSTRACT

A method includes obtaining data representative of a state or condition of an evaluation target. The method also includes providing first input based on the data to a trained classifier to generate a first result. The method further includes providing second input based on the data to an adaptive neuro-fuzzy inference system to generate a second result. The method also includes assigning a classification to the state or condition of the evaluation target based on the first result and the second result.

### CROSS-REFERENCE TO RELATED APPLICATION

The present application claims priority from U.S. Provisional Patent Application No. 63/222,532 filed Jul. 16, 2021, entitled “SYSTEMS AND METHODS OF ASSIGNING A CLASSIFICATION TO A STATE OR CONDITION OF AN EVALUATION TARGET,” which is incorporated by reference herein in its entirety.

### BACKGROUND

Machine learning can be integrated with a computer system to predict conditions or events based on data available to the computer system. For example, the computer system can use a machine-learning algorithm to build a model for predicting the conditions or events based on sample data (e.g., training data). Typically, the computer system can build or train a more accurate model as more sample data becomes available for building or training the model. However, in some scenarios, access to sample data for the use of building or training a machine-learning model may be limited. In these scenarios, predictions based on the machine-learning model may not be as accurate as predictions based on knowledge within the human domain, such as predictions made by human experts.

### SUMMARY

A particular aspect of the disclosure describes a method that includes obtaining data representative of a state or condition of an evaluation target. The method also includes providing first input based on the data to a trained classifier to generate a first result. The method further includes providing second input based on the data to an adaptive neuro-fuzzy inference system to generate a second result. The method also includes assigning a classification to the state or condition of the evaluation target based on the first result and the second result.

Another particular aspect of the disclosure describes a device that includes one or more processors and one or more memory devices accessible to the one or more processors. The one or more memory devices store instructions that are executable by the one or more processors to cause the one or more processors to obtain data representative of a state or condition of an evaluation target. The instructions are also executable by the one or more processors to cause the one or more processors to provide first input based on the data to a trained classifier to generate a first result. The instructions are further executable by the one or more processors to cause the one or more processors to provide second input based on the data to an adaptive neuro-fuzzy inference system to generate a second result. The instructions are also executable by the one or more processors to cause the one or more processors to assign a classification to the state or condition of the evaluation target based on the first result and the second result.

Another particular aspect of the disclosure describes a computer-readable storage device that stores instructions that are executable by one or more processors to perform operations. The operations include obtaining data representative of a state or condition of an evaluation target. The operations also include providing first input based on the data to a trained classifier to generate a first result. The operations further include providing second input based on the data to an adaptive neuro-fuzzy inference system to generate a second result. The operations also include assigning a classification to the state or condition of the evaluation target based on the first result and the second result.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 illustrates a particular embodiment of a system that is generally operable to classify a state or condition of an evaluation target.

FIG. 2 illustrates a particular example of classification system operations to classify a state or condition of an evaluation target.

FIG. 3 illustrates another particular example of classification system operations to classify a state or condition of an evaluation target.

FIG. 4 illustrates another particular example of classification system operations to classify a state or condition of an evaluation target.

FIG. 5 illustrates another particular example of classification system operations to classify a state or condition of an evaluation target.

FIG. 6 illustrates another particular example of classification system operations to classify a state or condition of an evaluation target.

FIG. 7 illustrates a particular embodiment of the adaptive neuro-fuzzy inference system that is generally operable to classify a state or condition of an evaluation target.

FIG. 8 illustrates a particular embodiment of a graphical user interface that is operable to receive user input to adjust parameters of the adaptive neuro-fuzzy inference system.

FIG. 9 illustrates a flowchart of a particular example of a method of classifying a state or condition of an evaluation target.

FIG. 10 is a diagram of a particular example of a system to generate one or more trained models that are used in conjunction with classifying a state or condition of an evaluation target in accordance with some examples of the present disclosure.

FIG. 11 is a block diagram of a computer system configured to initiate, perform, or control one or more of the operations described with reference to FIGS. 1-10.

### DETAILED DESCRIPTION

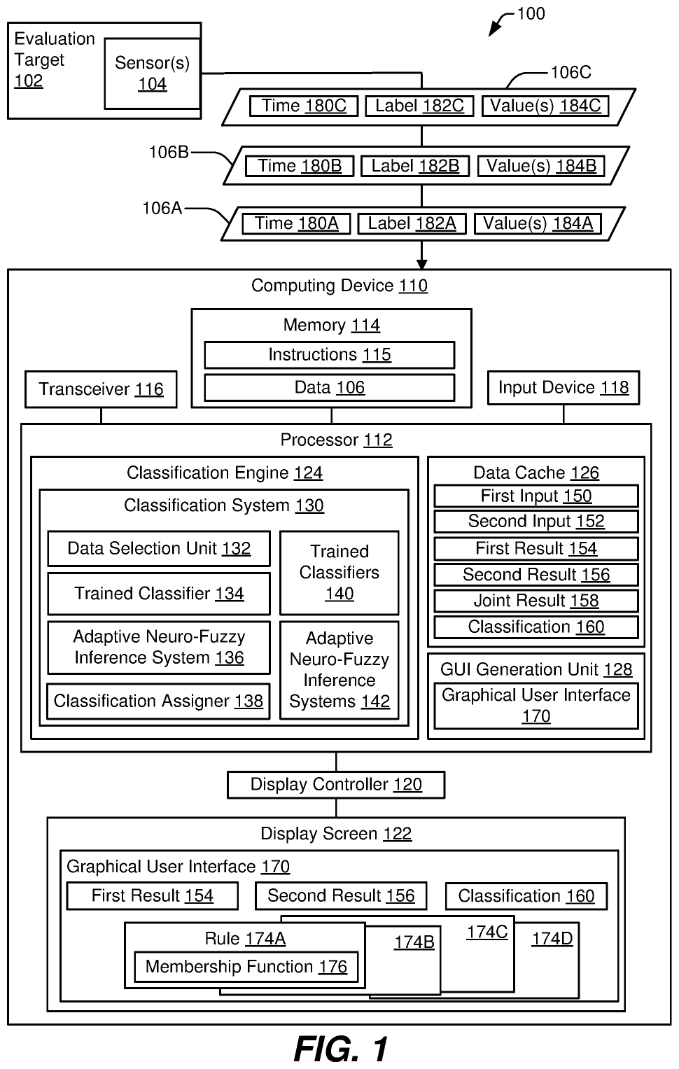

Particular aspects of the present disclosure are described below with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, data is illustrated and associated with reference numbers 106A, 106B, and 106C. When referring to particular data 106, such as the data 106A, the distinguishing letter “A” is used. However, when referring to any arbitrary data or the data as a group, the reference number 106 is used without a distinguishing letter.

As used herein, various terminology describing particular implementations is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. As used herein, “automated model building” or “AMB” refers to an extension of such machine learning to a situation in which the model type, the model architecture, or both, are not specified in advance. Thus, a computing device executing AMB software (also referred to as an “AMB engine”) automatically selects one or more model types, one or more model architectures, or both, to generate a model (or models). The AMB engine may also train and test one or more models in order to generate a machine-learning model based on a set of input data and specified goals, such as an indication of one or more data fields of the input data that are to be modeled, limits on a type or architecture of machine-learning model, a model-building termination condition, etc. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that the during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

One example of a machine-learning model disclosed herein is an adaptive neural-fuzzy inference system” or “ANFIS”. As used herein, an “adaptive neural-fuzzy inference system” or “ANFIS” refers to a machine-learning model that integrates neural network principles and fuzzy logic principles in a single framework. In some implementations, an ANFIS includes five layers. The first layer (e.g., the fuzzification layer) takes input values (e.g., {X, Y}) and determines the degree to which each value is representative of a particular fuzzy set based on a membership function associated with the fuzzy set. For example, fuzzy sets are represented by generalized or vague descriptors, such as large, medium, and small, and the membership function associated with a fuzzy set mathematically maps a range of specific values to the fuzzy set. To illustrate, in the example above, the large fuzzy set may be represented by values in a first range, the medium fuzzy set may be represented by values in a second range, and the small fuzzy set may be represented by values in a third range. The first, second, and/or third ranges can overlap with one another. To illustrate, the large fuzzy set may include values from 100 to 1000 units and the medium fuzzy set may include values from 50 to 150 units, and the small fuzzy set may include values from 1 to 75 units. Using this example, in response to an input value of 110 units, the fuzzification layer generates a first output value indicating a degree to which the input value is representative of the large fuzzy set, generates a second output value indicating a degree to which the input value is representative of the medium fuzzy set, and generates a third output value indicating a degree to which the input value is representative of the small fuzzy set. In this example, the third output value may be equal to zero, because the input value is not within a range of values represented by the small fuzzy set. However, the first and second output values are non-zero. The specific value of each of the first and second output values depends on the membership function.

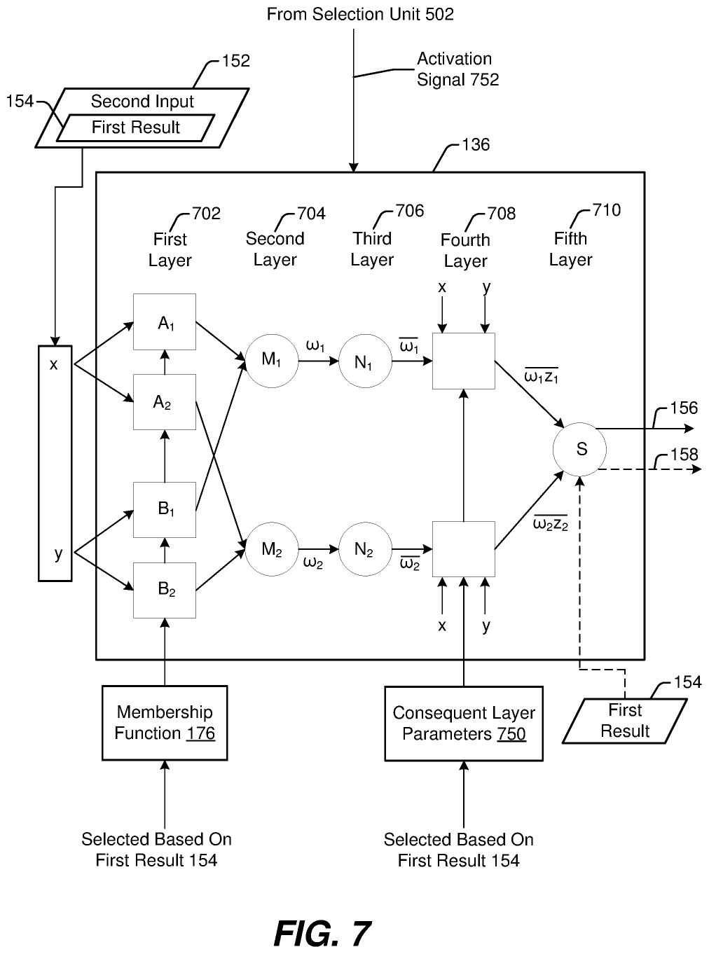

The second layer (e.g., the rule layer) generates firing strengths for rules or “fuzzy rules” of the ANFIS. The “firing strength” of a rule is based on the product of the input membership functions such that the output of each node of the second layer is the product of all incoming signals. The third layer may normalize the computed firing strengths by dividing each value by the total firing strength. The fourth layer receives the normalized values and a consequent parameter set to return defuzzified values. The fifth layer (e.g., the output layer) generates an output that is a weighted average of each fuzzy rule's output. ANFIS is described in greater detail with respect to FIG. 7.

FIG. 1 illustrates a particular embodiment of a system 100 that is generally operable to classify a state or condition of an evaluation target. The system 100 includes an evaluation target 102 and a computing device 110.

The evaluation target 102 can correspond to a device or object that is subject to evaluation or assessment. As non-limiting examples, the evaluation target 102 can include one or more electronic devices, one or more electromechanical devices, one or more pneumatic devices, one or more hydraulic devices, one or more mechanical devices, one or more radiologic devices, one or more other devices, or a combination thereof. In one implementation, the evaluation target 102 can include a naturally occurring biological or geological feature. To illustrate, the evaluation target 102 can include a geological structure that is associated with or sampled via a bore hole. For example, the bore hole may be used to extract oil or gas from a rock core geological structure. In this example, the geological structure may be evaluated or assessed (as the evaluation target 102) to determine whether the geological structure has particular features of interest, such as shale. It should be understood that the above examples of the evaluation target 102 are merely for illustrative purposes and are not intended to be limiting.

A plurality of sensors 104 can be coupled to, or included in, the evaluation target 102. Each sensor of the plurality of sensors 104 is configured to generate data 106 representative of a state or condition of the evaluation target 102. As a non-limiting example, if the evaluation target 102 includes a bore hole, the plurality of sensors 104 can include a downhole sensor system. In this example, the data 106 generated by the plurality of sensors 104 may include sensor data from the downhole sensor system. The sensor data (e.g., the data 106) can indicate water level measurements, bore hole depth measurements, wall structure measurements, etc.

In the illustrative example of FIG. 1, the plurality of sensors 104 generate data 106A, data 106B, and data 106C. It should be understood that although three instances of data 106A-106C are illustrated, in other implementations, the plurality of sensors 104 can generate additional instances or values of data 106. For example, in some implementations, the plurality of sensors 104 can generate thousands or millions of instances of data 106. According to some implementations, each sensor of the plurality of sensors 104 can be located at different areas of the evaluation target 102 such that the data 106 generated by the plurality of sensors 104 is reflective of the state or condition at different areas of the evaluation target 102. For example, if the evaluation target 102 is a bore hole, sensors at different depths within the bore hole generate sensor data (e.g., temperature data, pressure data, etc.) at different depths of the bore hole. According to some implementations, the evaluation target 102, the sensors 104, or both, can move over time. For example, if the evaluation target 102 is a bore hole, one or more of the sensors 104 can be lowered into the bore hole to collect data at various depths. The plurality of sensors 104 may provide the data 106 to the computing device 110.

The computing device 110 includes a processor 112, a memory 114 coupled to the processor 112, a transceiver 116 coupled to the processor 112, an input device 118 coupled to the processor 112, a display controller 120 coupled to the processor 112, and a display screen 122 coupled to the display controller 120.

The transceiver 116 is configured to transmit data from the computing device 110 to one or more external devices and is configured receive data from the one or more external devices. According to one implementation, the transceiver 116 is configured to receive the data 106 from the plurality of sensors 104 associated with the evaluation target 102. As a non-limiting example, the transceiver 116 may be a wireless transceiver that receives the data 106 over a wireless connection. As another non-limiting example, the transceiver 116 may correspond to a wired connection that couples the computing device 110 to receive the data 106 from the plurality of sensors 104.

The memory 114 may be a non-transitory computer-readable device or medium that stores instructions 115 executable by the processor 112. For example, the instructions 115 are executable by the processor 112, or by components within the processor 112, to perform the operations described herein. The memory 114 may also store the data 106 received from the plurality of sensors 104.

The processor 112 includes a classification engine 124, a data cache 126, and a graphical user interface generation unit 128. The processor 112 is configured to execute the classification engine 124 to perform the operations described herein. The classification engine 124 includes a classification system 130. The classification system 130 includes a data selection unit 132, a trained classifier 134, an adaptive neuro-fuzzy inference system 136, a classification assigner 138, a plurality of trained classifiers 140, and a plurality of adaptive neuro-fuzzy inference systems 142. According to some implementations, one or more components of the classification system 130 can be implemented using dedicated circuitry, such as an application-specific integrated circuit (ASIC) or a field programmable gate array (FPGA). According to some implementations, one or more components of the classification system 130 can be implemented using software (e.g., instructions 115 executable by the processor 112).

According to one implementation, the trained classifier 134 may be included in the plurality of trained classifiers 140. For example, the trained classifier 134 can be selected from the plurality of trained classifiers 140 for use based on one or more parameters, such as an output of the adaptive neuro-fuzzy inference system 136, as described below. Similarly, according to one implementation, the adaptive neuro-fuzzy inference system 136 may be included in the plurality of adaptive neuro-fuzzy inference systems 142. For example, the adaptive neuro-fuzzy inference system 136 can be selected from the plurality of adaptive neuro-fuzzy inference systems 142 based on one or more parameters, such as an output of the trained classifier 134, as described below.

The data selection unit 132 may be configured to obtain the data 106 from the plurality of sensors 104 or from the memory 114. For example, the data selection unit 132 may be communicatively coupled to receive the data 106 from the plurality of sensors 104 or from the memory 114. According to some implementations, the data selection unit 132 receives the data 106 via a wireless connection. According to other implementations, the data selection unit 132 receives the data 106 via a wired connection. According to the illustrated example, the data selection unit 132 is integrated into the classification engine 124 of the processor 112. In this example, the processor 112 can receive the data 106 via a wired or wireless connection. Upon reception of the data 106, the processor 112 can provide the data 106 to the data selection unit 132 (e.g., to the classification engine 124).

The data selection unit 132 may be configured to select at least a portion of data 106 received from the plurality of sensors 104 to be included in a first input 150, select at least a portion of the data 106 from the plurality of sensors 104 to be included in a second input 152, or both. According to one implementation, the first input 150 and the second input 152 may include the same data 106. For example, the data selection unit 132 may select particular values 184A-184C of the data 106 to be included in the first input 150 and may select the particular values 184A-184C (e.g., the same values) of the data 106 to be included in the second input 152. Alternatively, the first input 150 may include values 184 of a first set of variables selected from the data 106, and the second input 152 may include values 184 of a second set of variables selected from the data 106. In this scenario, the first set of variables may be distinct from the second set of variables such that the first input 150 and the second input 152 include different data 106.

According to one implementation, the data 106 corresponds to annotated time series data that includes annotations indicating time series segments and one or more labels 182. For example, the data 106A can include a first time annotation 180A, the data 106B can include a second time annotation 180B indicating that the data 106B was generated after the data 106A, the data 106C can include a third time annotation 180C indicating that the data 106C was generated after the data 106B, etc. Each label 182 of the one or more labels 180 may be associated with a corresponding time series segment of the one or more time series segments. Based on this implementation, the first input 150 may include first time series data of one of the time series segments. Additionally, or in the alternative, the second input 152 may include the first time series data of one of the times series segments.

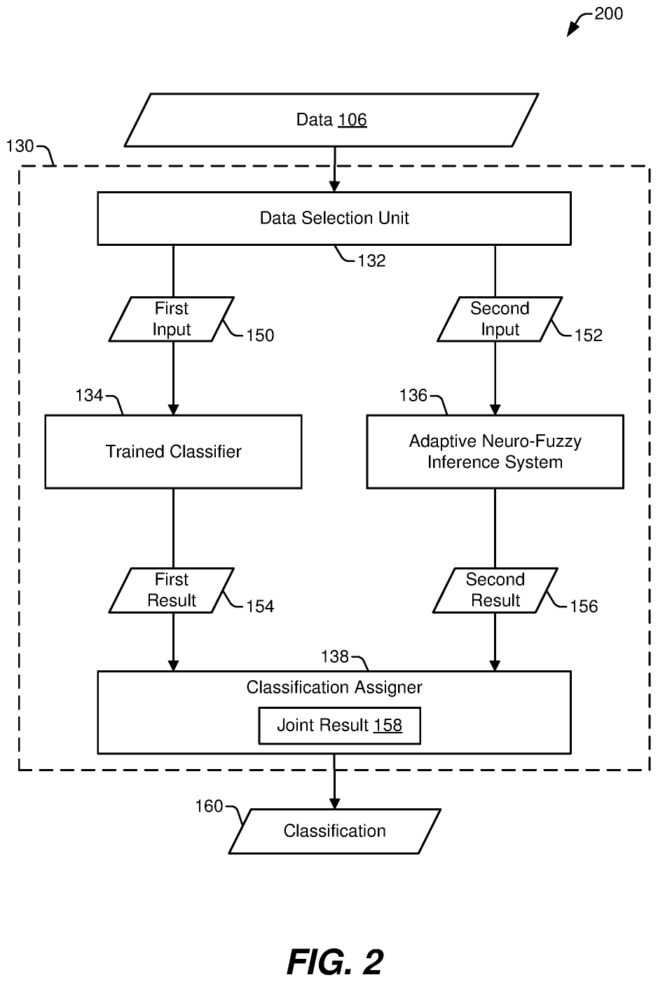

According to one implementation, and as further described with respect to FIG. 2, the data selection unit 132 is configured to provide the first input 150 to the trained classifier 134 to generate a first result 154 (e.g., a first classification of the state or condition of the evaluation target 102). According to one implementation, the trained classifier 134 corresponds to or includes a neural network. In some implementations, the trained classifier 134 corresponds to or includes one or more of a perceptron, a decision tree, a random forest, a Bayesian network, a logistic regression classifier, or a support vector machine. The trained classifier 134 can be trained based on input from a subject matter expert (SME). As a non-limiting example, a SME can annotate sensor data that is used to train the trained classifier 134. Based on the annotated sensor data and user input, the trained classifier 134 can learn parameters or rules used to classify or predict a state of the evaluation target 102 based on data, such as the data 106. For example, during training, if the first input 150 includes the first time series data, in some implementations, the trained classifier 134 may determine an error based on a difference between the first result 154 and an annotation associated with the first time series data. A parameter of the trained classifier 134 may be modified based on the error. To illustrate, a link weight used by the trained classifier 134 may be modified to reduce the error.

According to one implementation, and as further described with respect to FIG. 2, the data selection unit 132 is also configured to provide the second input 152 to the adaptive neuro-fuzzy inference system 136 to generate a second result 156 (e.g., a second classification of the state or condition of the evaluation target 102). The adaptive neuro-fuzzy inference system 136 is based on fuzzy logic that is learned from or specified by a SME. As a non-limiting example, a SME can annotate sensor data that is provided to the adaptive neuro-fuzzy inference system 136. Based on the annotated sensor data and user input, the adaptive neuro-fuzzy inference system 136 learns parameters or rules used to classify or predict a state of the evaluation target 102 based on data, such as the data 106. The adaptive neuro-fuzzy inference system 136 may generate the second result 156 using fuzzy logic and neural network principles. The second result 156 may represent outputs of a consequent layer of the adaptive neuro-fuzzy inference system 136. The first result 154 and the second result 156 may be provided to the classification assigner 138.

In some implementations, the second result 156 can be used to select the trained classifier 134 from among a plurality of trained classifiers 140. For example, the second result 156 may indicate a classification of the state or condition of the evaluation target 102 based on the adaptive neuro-fuzzy inference system 136. Based on the classification generated by the adaptive neuro-fuzzy inference system 136 (e.g., the second result 156), the classification system 130 may select a particular trained classifier that is trained to classify objects having similar states or conditions. Thus, the trained classifier 134 may be selected from among the plurality of trained classifiers 140 based on similarities between the classification of the adaptive neuro-fuzzy inference system 136 and how the trained classifier 134 is trained.

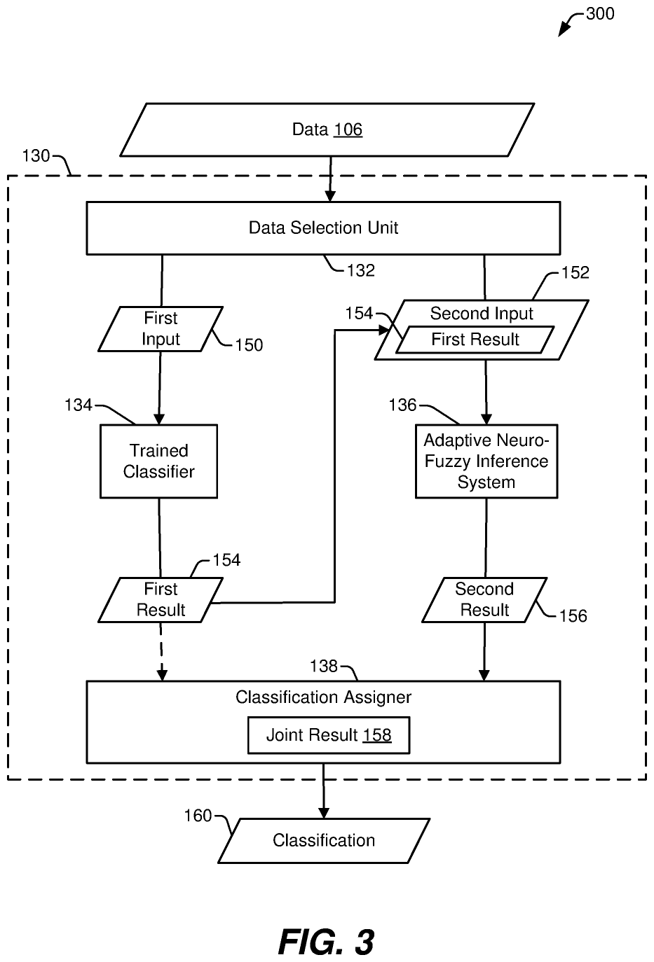

According to one implementation, and as further described with respect to FIG. 3, the first result 154 generated by the trained classifier 134 may be included in the second input 152 that is provided to the adaptive neuro-fuzzy inference system 136. According to one implementation, the first result 154 corresponds to the second input 152 such that the output of the trained classifier 134 is provided to the adaptive neuro-fuzzy inference system 136. According to another implementation, the first result 154 is combined with data 106 selected by the data selection unit 132 such that the second input 152 includes the selected data 106 and the first result 154. According to one implementation, the first result 154 is also provided to the classification assigner 138.

In the above implementation where the first result 154 is included in the second input 152, the first result 154 can be used by the adaptive neuro-fuzzy inference system 136 to select rules 174, determine parameters of one or more membership functions 176, or both. For example, according to one implementation, the adaptive neuro-fuzzy inference system 136 may be configured to generate the second result 156 based on a subset of rules 174A, 174B of a plurality of rules 174A-174D. According to this implementation, the adaptive neuro-fuzzy inference system 136 may select the subset of rules 174A, 174B from among the plurality of rules 174A-174D based on the first result 154. According to another implementation, the adaptive neuro-fuzzy inference system 136 may be configured to generate the second result 156 based on one or more membership functions 176. According to this implementation, the adaptive neuro-fuzzy inference system 136 may determine parameters of the one or more membership functions 176 based on the first result 154.

In some implementations, the first result 154 can be used to select the adaptive neuro-fuzzy inference system 136 from among a plurality of adaptive neuro-fuzzy inference systems 142. For example, the first result 154 may indicate a classification of the state or condition of the evaluation target 102 based on the trained classifier 134. Based on the classification generated by the trained classifier 134 (e.g., the first result 154), the classification system 130 may select a particular adaptive neuro-fuzzy inference system that is trained to classify objects having similar states or conditions. Thus, the adaptive neuro-fuzzy inference system 136 may be selected from among the plurality of adaptive neuro-fuzzy inference systems 142 based on similarities between the classification of the trained classifier 134 and how the adaptive neuro-fuzzy inference system 136 is trained.

The classification assigner 138 is configured to assign a classification 160 to the state or condition of the evaluation target 102 based on the first result 154 and the second result 156. To illustrate, the classification assigner 138 may determine a joint result 158 based on the first result 154 and the second result 156. According to one implementation, the classification assigner 138 may determine the joint result 158 by determining a product or sum of values of the first result 154 and the second result 156. According to another implementation, the classification assigner 138 may determine the joint result 158 by determining, based on values of the first result 154 and the second result 156, a floor value or a ceiling value. In this implementation, the joint result 158 may correspond to the floor value or the ceiling value. According to yet another implementation, the classification assigner 138 may determine the joint result 158 by applying one or more Boolean operations to values of the first result 154 and the second result 156. The classification 160 assigned to the state or condition of the evaluation target 102 may be based on the joint result 158. For example, the value(s) of the joint result 158 can indicate the state or condition of the evaluation target 102. As a non-limiting illustration, if the evaluation target 102 is a geological structure associated with a bore hole, the value(s) of the joint result 158 can indicate the presences of or locations of particular strata.

The graphical user interface (GUI) generation unit 128 is configured to generate a graphical user interface 170. Upon generation, the display controller 120 can output the graphical user interface 170 to the display screen 122. The graphical user interface 170 may indicate the classification 160 of the state or condition of the evaluation target 102, the first result 154 (e.g., the classification of the trained classifier 134), the second result 156 (e.g., the classification of the adaptive neuro-fuzzy inference system 136), or a combination thereof.

According to one implementation, the graphical user interface 170 may also include representations of rules 174 used by the adaptive neuro-fuzzy inference system 136 to generate the second result 156. The representations of the rules 174 may include a graphical representation of at least one membership function 176 used by the adaptive neuro-fuzzy inference system 136. According to one implementation, the graphical user interface 170 includes a representation of a dominant rule, such as the rule 174A, used by the adaptive neuro-fuzzy inference system 136 to generate the second result 156. As used herein, a “dominant rule” corresponds to a rule (or a parameter associated with the rule) that is prioritized over other rules (or parameters) during the classification of a state or condition. For example, if two or more different rules (or parameters) can be applied at a particular stage of the classification, the dominant rule would take precedence over the other rules. In some scenarios, the dominant rule 174A can be displayed with a distinctive text or with a visible label indicating that the rule 174A is dominant.

The input device 118 may be a device that enables a user to provide information or instructions. For example, the input device 118 may include a keyboard, a mouse, etc. According to one implementation, the input device 118 can be used to indicate a modification of one or more of the rules 174. In response to receiving an input indicating a modification of one or more of the rules 174, the processor 112 may modify one or more parameters of the adaptive neuro-fuzzy inference system 136.

The techniques described with respect to FIG. 1 enable improved classifications 160 of the state or condition of the evaluation target 102. For example, by using both the trained classifier 134 and the adaptive neuro-fuzzy inference system 136 (e.g., “fuzzy logic”) to generate the classification results 154, 156, respectively, the classification system 130 is able to classify the state or condition of the evaluation target 102 using a relatively small amount of data 106. As a result, in scenarios where a relatively small amount of data 106 is available, the classification system 130 can accurately classify the state or condition of the evaluation target 102 using the data 106 as opposed to conventional classification systems that may require additional data for accurate classifications.

Thus, the techniques described with respect to FIG. 1 enable a machine-learning system (e.g., the classification system 130) to supplement or replace SME analysis when a relatively small amount of training data is available. For example, the trained classifier 134 and the adaptive neuro-fuzzy inference system 136 can be trained using a relatively small amount of data. The adaptive neuro-fuzzy inference system 136 captures rules used by SMEs to make decisions (e.g., predictions, classifications, etc.). The rules used by the adaptive neuro-fuzzy inference system 136 may be graphically and textually represented to the SME for verification or correction. Thus, the adaptive neuro-fuzzy inference system 136 may provide decisions that are similar to decisions provided by SMEs because the adaptive neuro-fuzzy inference system 136 replicates rules by SMEs and enables SMEs to intervene.

The trained classifier 134 can capture hidden or latent dependencies that SMEs may forget or may not be aware of. As a result, the trained classifier 134 can capture dependencies that may not be captured by the adaptive neuro-fuzzy inference system 136. Thus, decisions based on a combined output of the trained classifier 134 and the adaptive neuro-fuzzy inference system 136 can be used to replace or supplement SME analysis. Additionally, the trained classifier 134 and the adaptive neuro-fuzzy inference system 136 can be updated as additional data becomes available so that eventually the combined output is an improvement over decisions made by an SME.

FIG. 2 illustrates a particular example 200 of classification system operations to classify a state or condition of an evaluation target.

According to the example 200 of FIG. 2, the data selection unit 132 may be configured to select at least a portion of data 106 received from the plurality of sensors 104 to be included in the first input 150, select at least a portion of the data 106 from the plurality of sensors 104 to be included in the second input 152, or both. According to one implementation, the first input 150 and the second input 152 may include the same data 106. For example, the data selection unit 132 may select particular values 184A-184C of the data 106 to be included in the first input 150 and may select the particular values 184A-184C (e.g., the same values) of the data 106 to be included in the second input 152. Alternatively, the first input 150 may include values 184 of a first set of variables selected from the data 106, and the second input 152 may include values 184 of a second set of variables selected from the data 106. In this scenario, the first set of variables may be distinct from the second set of variables such that the first input 150 and the second input 152 include different data 106.

According to the example 200 of FIG. 2, the data selection unit 132 is configured to provide the first input 150 to the trained classifier 134 to generate the first result 154 (e.g., a first classification of the state or condition of the evaluation target 102). The data selection unit 132 is also configured to provide the second input 152 to the adaptive neuro-fuzzy inference system 136 to generate the second result 156 (e.g., a second classification of the state or condition of the evaluation target 102). The first result 154 and the second result 156 may be provided to the classification assigner 138.

According to the example 200 of FIG. 2, the classification assigner 138 is configured to assign the classification 160 to the state or condition of the evaluation target 102 based on the first result 154 and the second result 156. To illustrate, the classification assigner 138 may determine the joint result 158 based on the first result 154 and the second result 156, as described above. The classification 160 assigned to the state or condition of the evaluation target 102 may be based on the joint result 158. For example, the value(s) of the joint result 158 can indicate the state or condition of the evaluation target 102. As a non-limiting illustration, if the evaluation target 102 is a geological structure associated with a bore hole, the value(s) of the joint result 158 can indicate the presences of or locations of particular strata.

The techniques described with respect to FIG. 2 enable improved classifications 160 of the state or condition of the evaluation target 102. For example, by using both the trained classifier 134 and the adaptive neuro-fuzzy inference system 136 (e.g., “fuzzy logic”) to generate the classification results 154, 156, respectively, the classification system 130 is able to classify the state or condition of the evaluation target 102 using a relatively small amount of data 106. As a result, in scenarios where a relatively small amount of data 106 is available, the classification system 130 can accurately classify the state or condition of the evaluation target 102 using the data 106 as opposed to conventional classification systems that may require additional data for accurate classifications.

Thus, the techniques described with respect to FIG. 2 enable a machine-learning system to supplement or replace SME analysis when a relatively small amount of training data is available. For example, the trained classifier 134 and the adaptive neuro-fuzzy inference system 136 can be trained using a relatively small amount of data. The adaptive neuro-fuzzy inference system 136 captures rules used by SMEs to make decisions (e.g., predictions, classifications, etc.). The rules used by the adaptive neuro-fuzzy inference system 136 may be graphically and textually represented to the SME for verification or correction. Thus, the adaptive neuro-fuzzy inference system 136 may provide decisions that are similar to decisions provided by SMEs because the adaptive neuro-fuzzy inference system 136 replicates rules by SMEs and enables SMEs to intervene.

The trained classifier 134 can capture hidden or latent dependencies that SMEs may forget or may not be aware of. As a result, the trained classifier 134 can capture dependencies that may not be captured by the adaptive neuro-fuzzy inference system 136. Thus, decisions based on a combined output of the trained classifier 134 and the adaptive neuro-fuzzy inference system 136 can be used to replace or supplement SME analysis. Additionally, the trained classifier 134 and the adaptive neuro-fuzzy inference system 136 can be updated as additional data becomes available so that eventually the combined output is an improvement over decisions made by an SME.

FIG. 3 illustrates another particular example 300 of classification system operations to classify a state or condition of an evaluation target. The example 300 illustrated in FIG. 3 is substantially similar to the example 200 illustrated in FIG. 2. However, as described below, according to the example 300 of FIG. 3, the input to the adaptive neuro-fuzzy inference system 136 is based on results of the trained classifier 134.

According to the example 300 of FIG. 3, the first result 154 generated by the trained classifier 134 is included in the second input 152 that is provided to the adaptive neuro-fuzzy inference system 136. According to one implementation, the first result 154 corresponds to the second input 152 such that the output of the trained classifier 134 is provided to the adaptive neuro-fuzzy inference system 136. According to another implementation, the first result 154 is combined with data 106 selected by the data selection unit 132 such that the second input 152 includes the selected data 106 and the first result 154. According to one implementation, the first result 154 is also provided to the classification assigner 138.

The first result 154 can be used by the adaptive neuro-fuzzy inference system 136 to select rules 174, determine parameters of one or more membership functions 176, or both. For example, according to one implementation, the adaptive neuro-fuzzy inference system 136 may be configured to generate the second result 156 based on a subset of rules 174A, 174B of the plurality of rules 174. According to this implementation, the adaptive neuro-fuzzy inference system 136 may select the subset of rules 174A, 174B from among the plurality of rules 174 based on the first result 154. According to another implementation, the adaptive neuro-fuzzy inference system 136 may be configured to generate the second result 156 based on one or more membership functions 176. According to this implementation, the adaptive neuro-fuzzy inference system 136 may determine parameters of the one or more membership functions 176 based on the first result 154.

The classification assigner 138 is configured to assign the classification 160 to the state or condition of the evaluation target 102 based on the first result 154 and the second result 156B, as described above. The techniques described with respect to FIG. 3 enable improved classifications 160 of the state or condition of the evaluation target 102. For example, by using an output of the trained classifier 134 to provide an input to the adaptive neuro-fuzzy inference system 136, the classification system 130 can classify the state or condition of the evaluation target 102 using a relatively small amount of data 106 by using both neural network architectures and fuzzy rules. As a result, in scenarios where a relatively small amount of data 106 is available, the classification system 130 can accurately classify the state or condition of the evaluation target 102 using the data 106 as opposed to conventional classification systems that may require additional data for accurate classifications.

Thus, the techniques described with respect to FIG. 3 enable a machine-learning system to supplement or replace SME analysis when a relatively small amount of training data is available. For example, the trained classifier 134 and the adaptive neuro-fuzzy inference system 136 can be trained using a relatively small amount of data. The adaptive neuro-fuzzy inference system 136 captures rules used by SMEs to make decisions (e.g., predictions, classifications, etc.). The rules used by the adaptive neuro-fuzzy inference system 136 may be graphically and textually represented to the SME for verification or correction. Thus, the adaptive neuro-fuzzy inference system 136 may provide decisions that are similar to decisions provided by SMEs because the adaptive neuro-fuzzy inference system 136 replicates rules by SMEs and enables SMEs to intervene.

The trained classifier 134 can capture hidden or latent dependencies that SMEs may forget or may not be aware of. As a result, the trained classifier 134 can capture dependencies that may not be captured by the adaptive neuro-fuzzy inference system 136. Thus, decisions based on a combined output of the trained classifier 134 and the adaptive neuro-fuzzy inference system 136 can be used to replace or supplement SME analysis. Additionally, the trained classifier 134 and the adaptive neuro-fuzzy inference system 136 can be updated as additional data becomes available so that eventually the combined output is an improvement over decisions made by an SME.

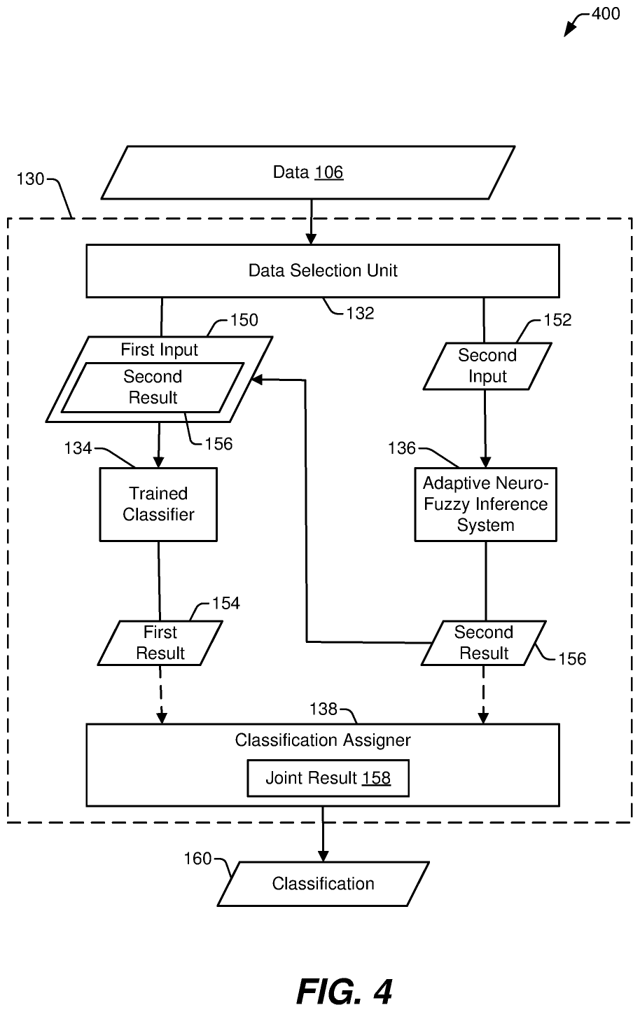

FIG. 4 illustrates another particular example 400 of classification system operations to classify a state or condition of an evaluation target. The example 400 illustrated in FIG. 4 is substantially similar to the example 200 illustrated in FIG. 2. However, as described below, according to the example 400 of FIG. 4, the input to the trained classifier 134 is based on results of the adaptive neuro-fuzzy inference system 136.

According to the example 400 of FIG. 4, the second result 156 generated by the adaptive neuro-fuzzy inference system 136 is included in the first input 150 that is provided to the trained classifier 134. According to one implementation, the second result 156 corresponds to the first input 150 such that the output of the adaptive neuro-fuzzy inference system 136 is provided to the trained classifier 134. According to another implementation, the second result 156 is combined with data 106 selected by the data selection unit 132 such that the first input 150 includes the selected data 106 and the second result 156. According to one implementation, the second result 156 is also provided to the classification assigner 138.

The trained classifier 134 may generate the first result 154 based on the first input 150 and provide the first result 154 to the classification assigner 138. The classification assigner 138 is configured to assign the classification 160 to the state or condition of the evaluation target 102 based on the first result 154 and the second result 156, as described above.

The techniques described with respect to FIG. 4 enable improved classifications 160 of the state or condition of the evaluation target 102. For example, by using an output of the adaptive neuro-fuzzy inference system 136 to provide an input to the trained classifier 134, the use of both neural network architectures and fuzzy rules enables the classification system 130 to classify the state or condition of the evaluation target 102 using a relatively small amount of data 106. Thus, in scenarios where a relatively small amount of data 106 is available, the classification system 130 can accurately classify the state or condition of the evaluation target 102 using the data 106 as opposed to conventional classification systems that may require additional data for accurate classifications.

Thus, the techniques described with respect to FIG. 4 enable a machine-learning system to supplement or replace SME analysis when a relatively small amount of training data is available. For example, the trained classifier 134 and the adaptive neuro-fuzzy inference system 136 can be trained using a relatively small amount of data. The adaptive neuro-fuzzy inference system 136 captures rules used by SMEs to make decisions (e.g., predictions, classifications, etc.). The rules used by the adaptive neuro-fuzzy inference system 136 may be graphically and textually represented to the SME for verification or correction. Thus, the adaptive neuro-fuzzy inference system 136 may provide decisions that are similar to decisions provided by SMEs because the adaptive neuro-fuzzy inference system 136 replicates rules by SMEs and enables SMEs to intervene.

The trained classifier 134 can capture hidden or latent dependencies that SMEs may forget or may not be aware of. As a result, the trained classifier 134 can capture dependencies that may not be captured by the adaptive neuro-fuzzy inference system 136. Thus, decisions based on a combined output of the trained classifier 134 and the adaptive neuro-fuzzy inference system 136 can be used to replace or supplement SME analysis. Additionally, the trained classifier 134 and the adaptive neuro-fuzzy inference system 136 can be updated as additional data becomes available so that eventually the combined output is an improvement over decisions made by an SME.

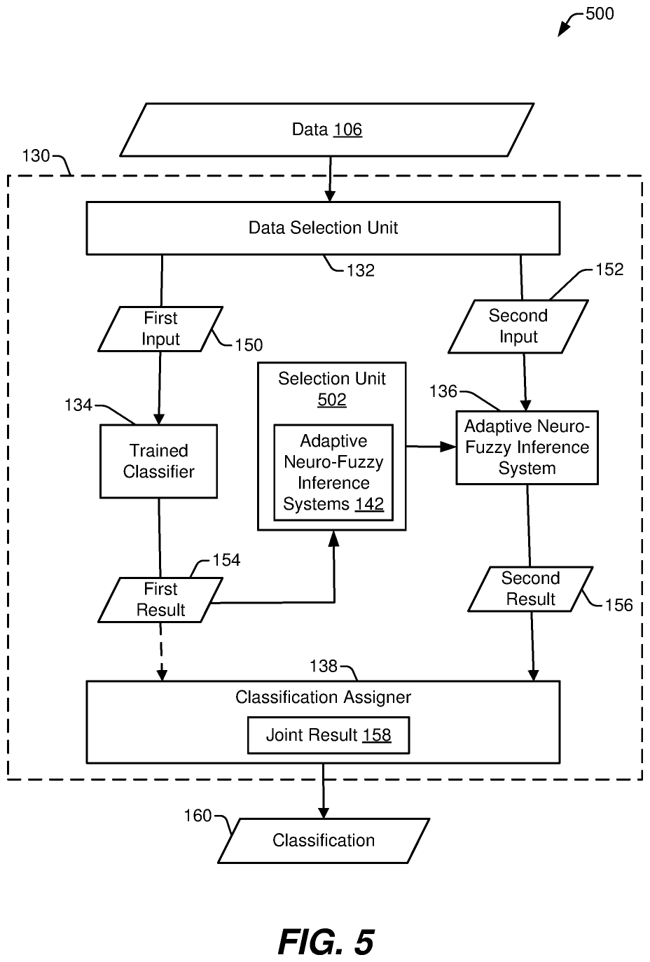

FIG. 5 illustrates another particular example 500 of classification system operations to classify a state or condition of an evaluation target. The example 500 illustrated in FIG. 5 is substantially similar to the example 200 illustrated in FIG. 2. However, as described below, according to the example 500 of FIG. 5, the output of the trained classifier 134 is used to select the adaptive neuro-fuzzy inference system 136 from the plurality of adaptive neuro-fuzzy inference systems 142.

According to the example 500 of FIG. 5, the first result 154 is provided to a selection unit 502. Based on the first result 154, the selection unit 502 can select a particular adaptive neuro-fuzzy inference system from among the plurality of neuro-fuzzy inference systems 142. For example, the first result 154 may indicate a classification of the state or condition of the evaluation target 102 based on the trained classifier 134. Based on the classification generated by the trained classifier 134 (e.g., the first result 154), the selection unit 502 may select a particular adaptive neuro-fuzzy inference system that is trained to classify items having similar states or conditions. Thus, in the illustrated example 500 of FIG. 5, the adaptive neuro-fuzzy inference system 136 may be selected from among the plurality of adaptive neuro-fuzzy inference systems 142 based on similarities between the classification of the trained classifier 134 and how the adaptive neuro-fuzzy inference system 136 is trained.

The selected adaptive neuro-fuzzy inference system 136 may generate the second result 156 based on the second input 152 and provide the second result 156 to the classification assigner 138. The second result 156 may represent outputs of a consequent layer of the adaptive neuro-fuzzy inference system 136, as further described with respect to FIG. 7.

The classification assigner 138 is configured to assign the classification 160 to the state or condition of the evaluation target 102 based on the first result 154 and the second result 156, as described above. The techniques described with respect to FIG. 5 enable improved classifications 160 of the state or condition of the evaluation target 102. For example, by using an output of the trained classifier 134 to select the adaptive neuro-fuzzy inference system 136 from among the plurality of adaptive neuro-fuzzy inference systems 142, the classification system 130 can classify the state or condition of the evaluation target 102 using fuzzy rules that are tailored to a classification (e.g., the first result 154) of the state or condition of the evaluation target 102.

Thus, the techniques described with respect to FIG. 5 enable a machine-learning system to supplement or replace SME analysis when a relatively small amount of training data is available. For example, the trained classifier 134 and the adaptive neuro-fuzzy inference system 136 can be trained using a relatively small amount of data. The adaptive neuro-fuzzy inference system 136 captures rules used by SMEs to make decisions (e.g., predictions, classifications, etc.). The rules used by the adaptive neuro-fuzzy inference system 136 may be graphically and textually represented to the SME for verification or correction. Thus, the adaptive neuro-fuzzy inference system 136 may provide decisions that are similar to decisions provided by SMEs because the adaptive neuro-fuzzy inference system 136 replicates rules by SMEs and enables SMEs to intervene.

The trained classifier 134 can capture hidden or latent dependencies that SMEs may forget or may not be aware of. As a result, the trained classifier 134 can capture dependencies that may not be captured by the adaptive neuro-fuzzy inference system 136. Thus, decisions based on a combined output of the trained classifier 134 and the adaptive neuro-fuzzy inference system 136 can be used to replace or supplement SME analysis. Additionally, the trained classifier 134 and the adaptive neuro-fuzzy inference system 136 can be updated as additional data becomes available so that eventually the combined output is an improvement over decisions made by an SME.

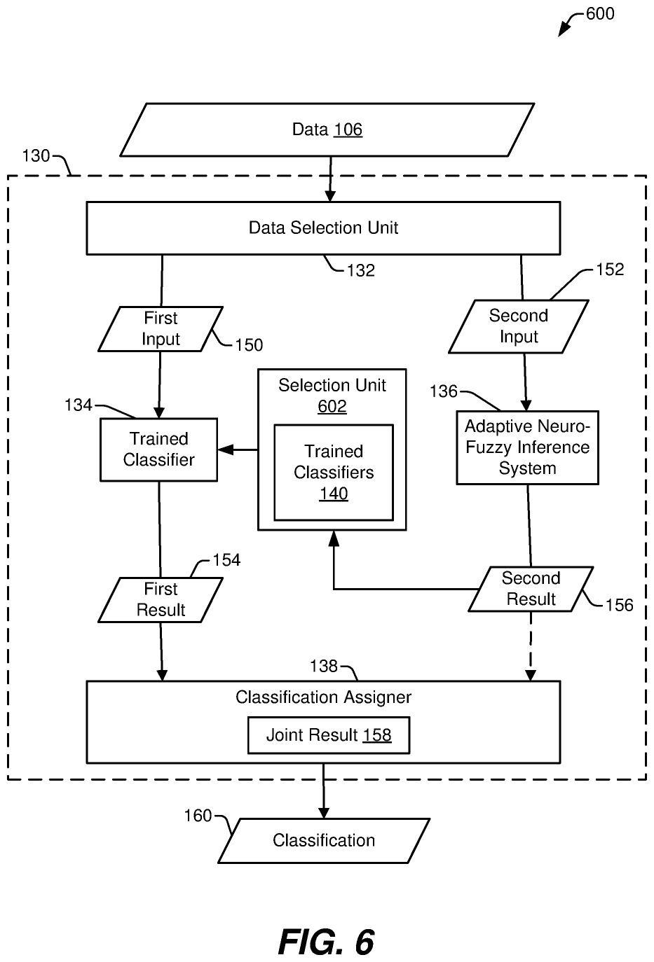

FIG. 6 illustrates another particular example 600 of classification system operations to classify a state or condition of an evaluation target. The example 600 illustrated in FIG. 6 is substantially similar to the example 200 illustrated in FIG. 2. However, as described below, according to the example 600 of FIG. 6, the output of the adaptive neuro-fuzzy inference system 136 is used to select the trained classifier 134 from the plurality of trained classifiers 140.

According to the example 600 of FIG. 6, the second result 156 is provided to a selection unit 602. Based on the second result 156, the selection unit 602 can select a particular trained classifier from among the plurality of trained classifiers 140. For example, the second result 156 may indicate a classification of the state or condition of the evaluation target 102 based on the adaptive neuro-fuzzy inference system 136. Based on the classification generated by the adaptive neuro-fuzzy inference system 136 (e.g., the second result 156), the selection unit 602 may select a particular trained classifier that is trained to classify items having similar states or conditions. Thus, in the illustrated example 600 of FIG. 6, the trained classifier 134 may be selected from among the plurality of trained classifiers 140 based on similarities between the classification of the adaptive neuro-fuzzy inference system 136 and how the trained classifier 134 is trained.

The selected trained classifier 134 may generate the first result 154 based on the first input 150 and provide the first result 154 to the classification assigner 138. The classification assigner 138 is configured to assign the classification 160 to the state or condition of the evaluation target 102 based on the first result 154 and the second result 156B, as described above. The techniques described with respect to FIG. 6 enable improved classifications 160 of the state or condition of the evaluation target 102. For example, by using an output of the adaptive neuro-fuzzy inference system 136 to select the trained classifier 134 from among the plurality of trained classifiers 140, the classification system 130 can classify the state or condition of the evaluation target 102 using a neural network architecture that is tailored to a classification based on fuzzy rules.

Thus, the techniques described with respect to FIG. 6 enable a machine-learning system to supplement or replace SME analysis when a relatively small amount of training data is available. For example, the trained classifier 134 and the adaptive neuro-fuzzy inference system 136 can be trained using a relatively small amount of data. The adaptive neuro-fuzzy inference system 136 captures rules used by SMEs to make decisions (e.g., predictions, classifications, etc.). The rules used by the adaptive neuro-fuzzy inference system 136 may be graphically and textually represented to the SME for verification or correction. Thus, the adaptive neuro-fuzzy inference system 136 may provide decisions that are similar to decisions provided by SMEs because the adaptive neuro-fuzzy inference system 136 replicates rules by SMEs and enables SMEs to intervene.

The trained classifier 134 can capture hidden or latent dependencies that SMEs may forget or may not be aware of. As a result, the trained classifier 134 can capture dependencies that may not be captured by the adaptive neuro-fuzzy inference system 136. Thus, decisions based on a combined output of the trained classifier 134 and the adaptive neuro-fuzzy inference system 136 can be used to replace or supplement SME analysis. Additionally, the trained classifier 134 and the adaptive neuro-fuzzy inference system 136 can be updated as additional data becomes available so that eventually the combined output is an improvement over decisions made by an SME.

FIG. 7 illustrates a particular embodiment of the adaptive neuro-fuzzy inference system 136 that is generally operable to classify a state or condition of an evaluation target. In particular, the adaptive neuro-fuzzy inference system 136 is operable to generate the second result 156 that is used by the classification assigner 138 to determine the classification 160 of the state or condition of the evaluation target 102.

In the illustrative example of FIG. 7, the architecture of the adaptive neuro-fuzzy inference system 136 includes a first layer 702, a second layer 704, a third layer 706, a fourth layer 708, and a fifth layer 710. To enable use of the adaptive neuro-fuzzy inference system 136 of FIG. 7 in conjunction with the classification system 130, the adaptive neuro-fuzzy inference system 136 may receive an activation signal 752 from a selection unit, such as the selection unit 502, based on the output of the trained classifier 134 (e.g., the first result 154), as described with respect to FIG. 5.

The adaptive neuro-fuzzy inference system 136 is configured to receive input values {x, y} that may otherwise be referred to as fuzzy set input values. The input values {x, y} may include the output of the trained classifier 134 (e.g., the first result 154), as described with respect to FIG. 3. The input values {x, y} may also, or alternatively, include one or more of the values 184 in the data 106 provided to the classification system 130. For example, the input values {x, y} can be selected by the data selection unit 132 to be provided to the adaptive neuro-fuzzy inference system 136 as the second input 152. The input value {x} may be a first variable value, and the input {y} may be a second variable value. For non-limiting illustrative purposes, the input {x} may be a pressure (e.g., Pascals) and the input {y} may be a temperature (e.g., Kelvins).

According to the example depicted in FIG. 7, the input values {x, y} are provided to the first layer 702 (e.g., the fuzzification layer). In the example illustrated in FIG. 7, the first layer 702 includes four nodes {A₁, A₂, B₁, B₂}, and each node applies a particular membership function 176 to it input value. As described with respect to FIG. 1, the membership functions 176 can be determined or selected based on the first result 154. For illustrative purposes, assuming pressure is described as large or small, and temperature is described as high or low. The node {A₁} may apply a large pressure membership function 176 and the node {A₂} may apply a small pressure membership function 176. In a similar manner, the node {B₁} may apply a high temperature membership function 176 and the node {B₂} may apply a low temperature membership function 176.

Each membership function 176 in the first layer 702 can be illustrated as a curve, and the degree to which a particular input value {x, y} maps to each membership function 176 is the output of the node {A₁, A₂, B₁, B₂} that applies the membership function 176. Thus, the output of the node {A₁} indicates the degree to which the input value {x} represents a large pressure, the output of the node {A₂} indicates the degree to which the input value {x} represents a small pressure, the output of the node {B₁} indicates the degree to which the input value {y} represents a high temperature, and the output of the node {B₂} indicates the degree to which the input value {y} represents a low temperature.

The outputs of the nodes {A₁, A₂, B₁, B₂} of the first layer 702 are provided to nodes {M₁, M₂} of the second layer 704. The nodes {M₁, M₂} of the second layer 704 (e.g., the rule layer) perform as multipliers. The outputs of the second layer 704 represent fuzzy strengths wᵢ of each rule.

The fuzzy strengths wᵢ are provided to nodes {N₁, N₂} of the third layer 706. The nodes {N₁, N₂} are used to normalize the fuzzy strengths wᵢ from the second layer 704. The normalization factor may be computed by the sum of the weight functions. The outputs of the third layer 506 are normalized fuzzy strengths w̅ᵢ.

The normalized fuzzy strengths w̅ᵢ are provided to nodes of the fourth layer 708 (e.g., a consequent layer). Consequent layer parameters 750 are applied to the normalized fuzzy strengths w̅ᵢ at the nodes of the fourth layer 708 to generate outputs w̅ᵢzᵢ. According to one implementation, the consequent layer parameters 750 may be selected based on the first result 154 (e.g., the output of the trained classifier 134). The second result 156 may represent the outputs w̅ᵢzᵢ of the consequent layer (e.g., the fourth layer 708) of the adaptive neuro-fuzzy inference system 136. For example, the fifth layer 710 (e.g., an output layer) includes a single fixed node that sums the outputs w̅ᵢzᵢ of the consequent layer, which may represent the second result 156.

According to one implementation, the outputs w̅ᵢzᵢ of the consequent layer (e.g., the fourth layer 708) can be joined with the first result 154 at the fifth layer 710. According to this implementation, the output of the adaptive neuro-fuzzy inference system 136 correspond to the joint result 158. Thus, in conjunction with the example of FIG. 1, according to one implementation, determining the joint result 158 may include combining a value of the first result 154 with outputs of the consequent layer 708 at the output layer 710 of the adaptive neuro-fuzzy inference system 136.

Thus, according to the example of FIG. 7, the first result 154 can be used by the adaptive neuro-fuzzy inference system 136 to select membership functions 176 applied by the nodes of the first layer 702, to select consequent layer parameters 750 applied at the fourth layer 708, to generate the joint result 158 by combining the outputs of the fourth layer 708 (e.g., the consequent layer) with the first result 154, or a combination thereof. Thus, the adaptive neuro-fuzzy inference system 136 of FIG. 7 enables fuzzy logic to be used in conjunction with the output of the trained classifier 134 (e.g., the first result 154) to generate the second result 156.

In scenarios where the second input 152 includes first time series data of time series segments, the adaptive neuro-fuzzy inference system 136 (or the classification system 130) may determine an error based on a difference between the second result 156 and an annotation associated with the first time series data. Based on the error, the adaptive neuro-fuzzy inference system 136 may modify a parameter. The modified parameters may include parameters of the membership functions 176 or consequent layer parameters 750. In some implementations, the modified parameters may include a logical connector of two or more premises.

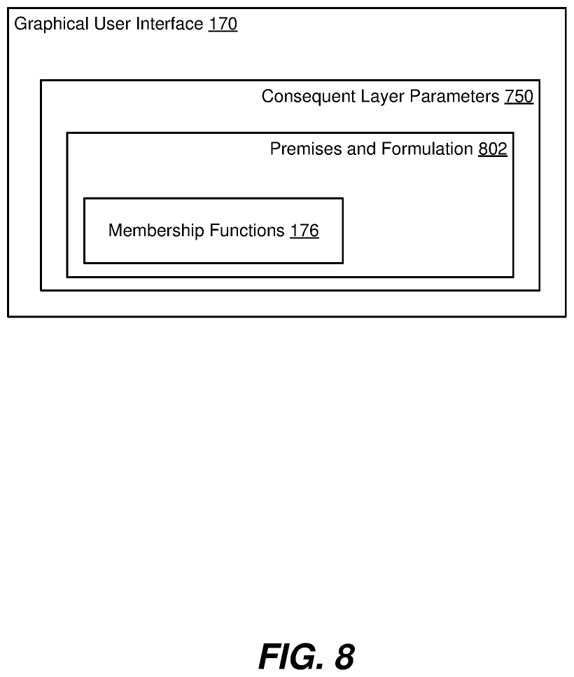

FIG. 8 illustrates a particular embodiment of the graphical user interface 170 that is operable to receive user input to adjust parameters of the adaptive neuro-fuzzy inference system 136. For example, the graphical user interface 170 can display representations of membership functions 176 used by the adaptive neuro-fuzzy inference system 136, consequent layer parameters 750 used by the adaptive neuro-fuzzy inference system 136, and logical connectors for premises and formulation 802 of the rules used by the adaptive neuro-fuzzy inference system 136.

According to the example of FIG. 8, the user (e.g., an SME) can select a number of levels or linguistic descriptors of the membership functions 176 used by the adaptive neuro-fuzzy inference system 136. For example, the representation of the membership functions 176 may be an interactive representation that allows the user to adjust the parameters. Additionally, the user may adjust the type of membership functions 176 and the parameter thresholds associated with the membership functions 176. For example, the user can select whether the membership function 176 use a triangular function or curve, a trapezoidal function or curve, a bell function or curve, etc. As non-limiting examples, the input device 118 may include different buttons or selectors that enable the user to select different types of membership functions 176. Thus, in scenarios whereby the user has a relatively high level of confidence regarding the shape, range, or other characteristics of the membership function 176, the user can select membership function 176. However, in some implementations, the user may have a relatively low level of confidence regarding the shape, range, or other characteristics of the membership function 176. In these implementations, the user can bypass selection of the membership function 176 and the membership function 176 can be selected during training of the adaptive neuro-fuzzy inference system 136. Alternatively, in the implementations where the user has a relatively low level of confidence regarding the shape, range, or other characteristics of the membership function 176, the user can select a particular membership function and adjust the characteristics of the particular membership function (or change the particular membership function) during training.

According to the example of FIG. 8, the user can also select the premises and formulation 802 of the rule antecedents used by the adaptive neuro-fuzzy inference system 136. The premises can indicate a variance, a slope, and a grade estimation for the rule antecedents. The formulation can indicate whether AND operators, OR operators, or both are used in conjunction with the premises. Thus, the formulation can indicate a logical connector of two or more premises. According to one implementation, if the user has a relatively high level of confidence regarding the premises and formulation 802 of the rule antecedents, the user can select (or adjust) the premises and formulation 802. For example, the user may select one or more conditional premises (e.g., if/then premises) that comprise the rule antecedents. However, if the user has relatively low level of confidence regarding the premises and formulation 802 of the rule antecedents to be used by the adaptive neuro-fuzzy inference system 136, the user can bypass selection of the premises and formulation 802 of the rule antecedents and the premises and formulation 802 can be selected during training of the adaptive neuro-fuzzy inference system 136. Alternatively, in the implementations where the user has a relatively low level of confidence regarding the premises and formulation 802 of the rule antecedents to be used by the adaptive neuro-fuzzy inference system 136, the user can select or define particular premises and a formulation. In response to selection of the particular premises and the formulation, the particular premises and formulation may undergo training to be adjusted or refined. In yet another implementation where the user has a relatively low level of confidence regarding the premises and formulation 802 of the rule antecedents to be used by the adaptive neuro-fuzzy inference system 136, the user can select or define particular premises and a formulation while other premises can be generated through training. Additionally, according to the example of FIG. 8, the user can select the consequent layer parameters 750 applied in the fourth layer 708 of the adaptive neuro-fuzzy inference system 136.

Thus, the processor 112 can generate the graphical user interface 170 of FIG. 8 that includes representations of rules used by the adaptive neuro-fuzzy inference system 136 to generate the second result 156. The processor 112 can also receive input, via the input device 118, indicating a modification of one or more of the rules and modifying one or more parameters of the adaptive neuro-fuzzy inference system 136. The one or more parameters may include the membership functions 176, the premises and formulation 802 of the rule antecedents (e.g., a logical connector of two or more premises), or the consequent layer parameters 750.

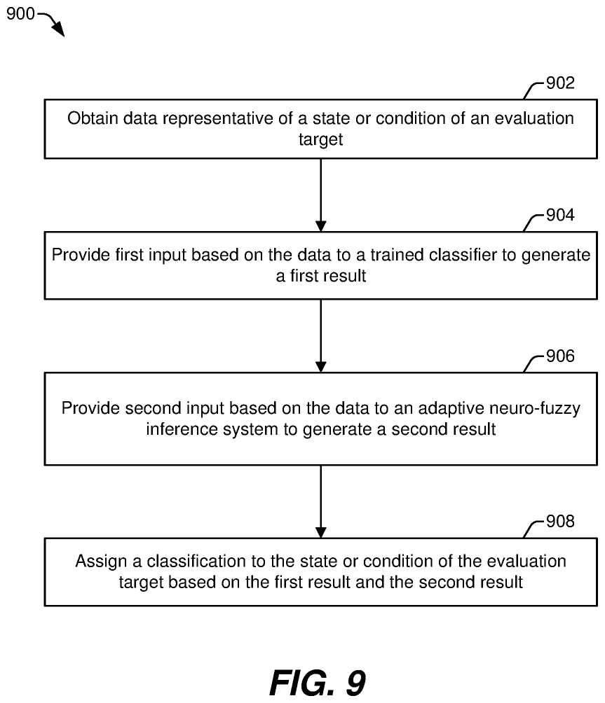

FIG. 9 illustrates a flowchart of a particular example of a method 900 of classifying a state or condition of an evaluation target. The method 900 may correspond to operations performed at the classification system 130. In particular, the method 900 may correspond to the operations described with respect to FIGS. 1-8.

The method 900 includes obtaining data representative of a state or condition of an evaluation target, at 902. For example, referring to FIG. 1, the classification system 130 obtains data 106 representative of the state or condition of the evaluation target 102. The data 106 may include sensor data from the plurality of sensors 104 associated with the evaluation target 102.

The method 900 also includes providing first input based on the data to a trained classifier to generate a first result, at 904. As a non-limiting example, referring to FIG. 1, the data selection unit 132 may provide the first input 150 to the trained classifier 134 based on the data 106. According to one implementation of the method 900, the first input includes the second result. For example, referring to FIG. 4, the first input 150 includes the second result 156 output by the adaptive neuro-fuzzy inference system 136.

The method 900 also includes providing second input based on the data to an adaptive neuro-fuzzy inference system to generate a second result, at 906. As a non-limiting example, referring to FIG. 1, the data selection unit 132 may provide the second input 152 to the adaptive neuro-fuzzy inference system 136 based on the data 106. According to one implementation of the method 900, the second input includes the first result. For example, referring to FIG. 3, the second input 152 includes the first result 154 output by the trained classifier 134.

The method 900 also includes assigning a classification to the state or condition of the evaluation target based on the first result and the second result, at 908. For example, referring to FIG. 1, the classification assigner 138 may assign the classification 160 to the state or condition of the evaluation target 102 based on the first result 154 and the second result 156. According to one implementation, the method 900 includes determining a joint result based on the first result and the second result. For example, referring to FIG. 1, the classification assigner 138 may determine the joint result 158 based on the first result 154 and the second result 156. The classification 160 may be based on the joint result 158. For example, the value(s) of the joint result 158 can indicate the state or condition of the evaluation target 102. As a non-limiting illustration, if the evaluation target 102 is a geological structure associated with a bore hole, the value(s) of the joint result 158 can indicate the presences of or locations of particular strata.

The method 900 of FIG. 9 enables improved classifications 160 of the state or condition of the evaluation target 102. For example, by using both the trained classifier 134 and the adaptive neuro-fuzzy inference system 136 (e.g., “fuzzy logic”) to generate the classification results 154, 156, respectively, the state or condition of the evaluation target 102 can be classified using a relatively small amount of data 106.

Thus, the method 900 enables a machine-learning system to supplement or replace SME analysis when a relatively small amount of training data is available. For example, the trained classifier 134 and the adaptive neuro-fuzzy inference system 136 can be trained using a relatively small amount of data. The adaptive neuro-fuzzy inference system 136 captures rules used by SMEs to make decisions (e.g., predictions, classifications, etc.). The rules used by the adaptive neuro-fuzzy inference system 136 may be graphically and textually represented to the SME for verification or correction. Thus, the adaptive neuro-fuzzy inference system 136 may provide decisions that are similar to decisions provided by SMEs because the adaptive neuro-fuzzy inference system 136 replicates rules by SMEs and enables SMEs to intervene.

The trained classifier 134 can capture hidden or latent dependencies that SMEs may forget or may not be aware of. As a result, the trained classifier 134 can capture dependencies that may not be captured by the adaptive neuro-fuzzy inference system 136. Thus, decisions based on a combined output of the trained classifier 134 and the adaptive neuro-fuzzy inference system 136 can be used to replace or supplement SME analysis. Additionally, the trained classifier 134 and the adaptive neuro-fuzzy inference system 136 can be updated as additional data becomes available so that eventually the combined output is an improvement over decisions made by an SME.

It should be understood that rules, judgements, and determinations established by the SME, or multiple SMEs, can change or adapt over time. For example, the rules, judgments, and determinations can be established over weeks, months, or years by a single SME or by multiple different SMEs. It should be appreciated that the techniques and systems described with respect to FIGS. 1-9 adapt the reasoning of the SMEs over time.

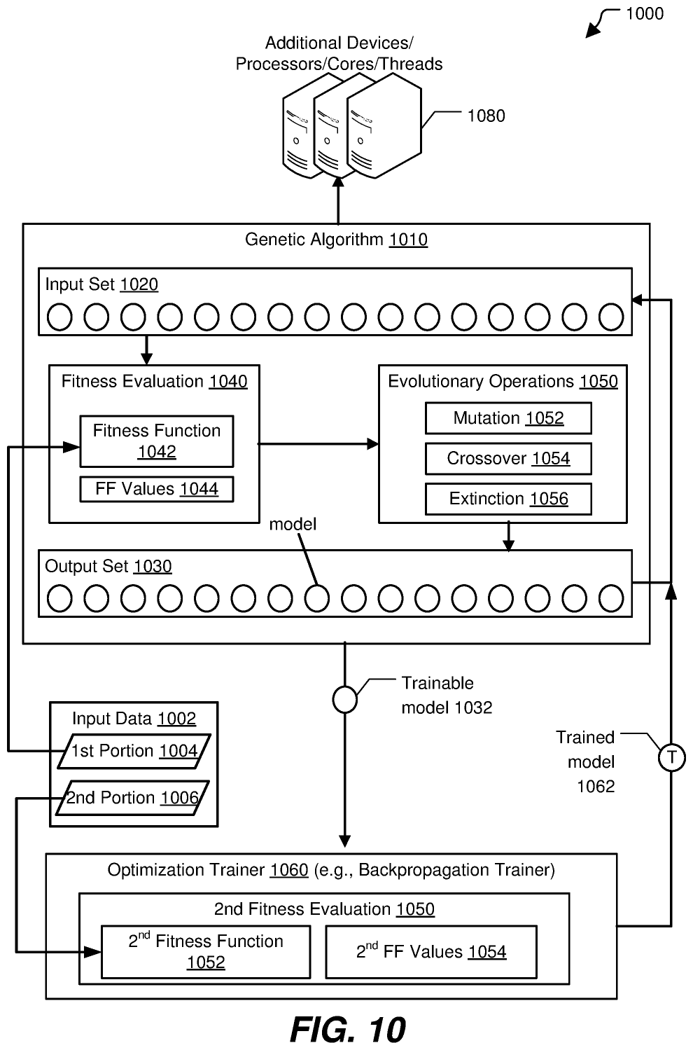

Referring to FIG. 10, a particular illustrative example of a system 1000 for generating a machine-learning data model, such as one or more of the trained classifiers 140, that can be used by the processors 112, the computing device 110, or both, is shown. Although FIG. 10 depicts a particular example for purpose of explanation, in other implementations other systems may be used for generating or updating one or more of the trained classifiers 140.

The system 1000, or portions thereof, may be implemented using (e.g., executed by) one or more computing devices, such as laptop computers, desktop computers, mobile devices, servers, and Internet of Things devices and other devices utilizing embedded processors and firmware or operating systems, etc. In the illustrated example, the system 1000 includes a genetic algorithm 1010 and an optimization trainer 1060. The optimization trainer 1060 is, for example, a backpropagation trainer, a derivative free optimizer (DFO), an extreme learning machine (ELM), etc. In particular implementations, the genetic algorithm 1010 is executed on a different device, processor (e.g., central processor unit (CPU), graphics processing unit (GPU) or other type of processor), processor core, and/or thread (e.g., hardware or software thread) than the optimization trainer 1060. The genetic algorithm 1010 and the optimization trainer 1060 are executed cooperatively to automatically generate a machine-learning data model (e.g., one of the trained classifiers 140, such as depicted in FIG. 1 and referred to herein as “models” for ease of reference), such as a neural network or an autoencoder, based on the input data 1002. The system 1000 performs an automated model building process that enables users, including inexperienced users, to quickly and easily build highly accurate models based on a specified data set.

During configuration of the system 1000, a user specifies the input data 1002. In some implementations, the user can also specify one or more characteristics of models that can be generated. In such implementations, the system 1000 constrains models processed by the genetic algorithm 1010 to those that have the one or more specified characteristics. For example, the specified characteristics can constrain allowed model topologies (e.g., to include no more than a specified number of input nodes or output nodes, no more than a specified number of hidden layers, no recurrent loops, etc.). Constraining the characteristics of the models can reduce the computing resources (e.g., time, memory, processor cycles, etc.) needed to converge to a final model, can reduce the computing resources needed to use the model (e.g., by simplifying the model), or both.

The user can configure aspects of the genetic algorithm 1010 via input to graphical user interfaces (GUIs). For example, the user may provide input to limit a number of epochs that will be executed by the genetic algorithm 1010. Alternatively, the user may specify a time limit indicating an amount of time that the genetic algorithm 1010 has to execute before outputting a final output model, and the genetic algorithm 1010 may determine a number of epochs that will be executed based on the specified time limit. To illustrate, an initial epoch of the genetic algorithm 1010 may be timed (e.g., using a hardware or software timer at the computing device executing the genetic algorithm 1010), and a total number of epochs that are to be executed within the specified time limit may be determined accordingly. As another example, the user may constrain a number of models evaluated in each epoch, for example by constraining the size of an input set 1020 of models and/or an output set 1030 of models.

The genetic algorithm 1010 represents a recursive search process. Consequently, each iteration of the search process (also called an epoch or generation of the genetic algorithm 1010) has an input set 1020 of models (also referred to herein as an input population) and an output set 1030 of models (also referred to herein as an output population). The input set 1020 and the output set 1030 may each include a plurality of models, where each model includes data representative of a machine-learning data model. For example, each model may specify a neural network or an autoencoder by at least an architecture, a series of activation functions, and connection weights. The architecture (also referred to herein as a topology) of a model includes a configuration of layers or nodes and connections therebetween. The models may also be specified to include other parameters, including but not limited to bias values/functions and aggregation functions.

For example, each model can be represented by a set of parameters and a set of hyperparameters. In this context, the hyperparameters of a model define the architecture of the model (e.g., the specific arrangement of layers or nodes and connections), and the parameters of the model refer to values that are learned or updated during optimization training of the model. For example, the parameters include or correspond to connection weights and biases.

In a particular implementation, a model is represented as a set of nodes and connections therebetween. In such implementations, the hyperparameters of the model include the data descriptive of each of the nodes, such as an activation function of each node, an aggregation function of each node, and data describing node pairs linked by corresponding connections. The activation function of a node is a step function, sine function, continuous or piecewise linear function, sigmoid function, hyperbolic tangent function, or another type of mathematical function that represents a threshold at which the node is activated. The aggregation function is a mathematical function that combines (e.g., sum, product, etc.) input signals to the node. An output of the aggregation function may be used as input to the activation function.

In another particular implementation, the model is represented on a layer-by-layer basis. For example, the hyperparameters define layers, and each layer includes layer data, such as a layer type and a node count. Examples of layer types include fully connected, long short-term memory (LSTM) layers, gated recurrent units (GRU) layers, and convolutional neural network (CNN) layers. In some implementations, all of the nodes of a particular layer use the same activation function and aggregation function. In such implementations, specifying the layer type and node count fully may describe the hyperparameters of each layer. In other implementations, the activation function and aggregation function of the nodes of a particular layer can be specified independently of the layer type of the layer. For example, in such implementations, one fully connected layer can use a sigmoid activation function and another fully connected layer (having the same layer type as the first fully connected layer) can use a tan h activation function. In such implementations, the hyperparameters of a layer include layer type, node count, activation function, and aggregation function. Further, a complete autoencoder is specified by specifying an order of layers and the hyperparameters of each layer of the autoencoder.

In a particular aspect, the genetic algorithm 1010 may be configured to perform speciation. For example, the genetic algorithm 1010 may be configured to cluster the models of the input set 1020 into species based on “genetic distance” between the models. The genetic distance between two models may be measured or evaluated based on differences in nodes, activation functions, aggregation functions, connections, connection weights, layers, layer types, latent-space layers, encoders, decoders, etc. of the two models. In an illustrative example, the genetic algorithm 1010 may be configured to serialize a model into a bit string. In this example, the genetic distance between models may be represented by the number of differing bits in the bit strings corresponding to the models. The bit strings corresponding to models may be referred to as “encodings” of the models.

After configuration, the genetic algorithm 1010 may begin execution based on the input data 1002. Parameters of the genetic algorithm 1010 may include but are not limited to, mutation parameter(s), a maximum number of epochs the genetic algorithm 1010 will be executed, a termination condition (e.g., a threshold fitness value that results in termination of the genetic algorithm 1010 even if the maximum number of generations has not been reached), whether parallelization of model testing or fitness evaluation is enabled, whether to evolve a feedforward or recurrent neural network, etc. As used herein, a “mutation parameter” affects the likelihood of a mutation operation occurring with respect to a candidate neural network, the extent of the mutation operation (e.g., how many bits, bytes, fields, characteristics, etc. change due to the mutation operation), and/or the type of the mutation operation (e.g., whether the mutation changes a node characteristic, a link characteristic, etc.). In some examples, the genetic algorithm 1010 uses a single mutation parameter or set of mutation parameters for all of the models. In such examples, the mutation parameter may impact how often, how much, and/or what types of mutations can happen to any model of the genetic algorithm 1010. In alternative examples, the genetic algorithm 1010 maintains multiple mutation parameters or sets of mutation parameters, such as for individual or groups of models or species. In particular aspects, the mutation parameter(s) affect crossover and/or mutation operations, which are further described below.

For an initial epoch of the genetic algorithm 1010, the topologies of the models in the input set 1020 may be randomly or pseudo-randomly generated within constraints specified by the configuration settings or by one or more architectural parameters. Accordingly, the input set 1020 may include models with multiple distinct topologies. For example, a first model of the initial epoch may have a first topology, including a first number of input nodes associated with a first set of data parameters, a first number of hidden layers including a first number and arrangement of hidden nodes, one or more output nodes, and a first set of interconnections between the nodes. In this example, a second model of the initial epoch may have a second topology, including a second number of input nodes associated with a second set of data parameters, a second number of hidden layers including a second number and arrangement of hidden nodes, one or more output nodes, and a second set of interconnections between the nodes. The first model and the second model may or may not have the same number of input nodes and/or output nodes. Further, one or more layers of the first model can be of a different layer type that one or more layers of the second model. For example, the first model can be a feedforward model, with no recurrent layers; whereas, the second model can include one or more recurrent layers.

The genetic algorithm 1010 may automatically assign an activation function, an aggregation function, a bias, connection weights, etc. to each model of the input set 1020 for the initial epoch. In some aspects, the connection weights are initially assigned randomly or pseudo-randomly. In some implementations, a single activation function is used for each node of a particular model. For example, a sigmoid function may be used as the activation function of each node of the particular model. The single activation function may be selected based on configuration data. For example, the configuration data may indicate that a hyperbolic tangent activation function is to be used or that a sigmoid activation function is to be used. Alternatively, the activation function may be randomly or pseudo-randomly selected from a set of allowed activation functions, and different nodes or layers of a model may have different types of activation functions. Aggregation functions may similarly be randomly or pseudo-randomly assigned for the models in the input set 1020 of the initial epoch. Thus, the models of the input set 1020 of the initial epoch may have different topologies (which may include different input nodes corresponding to different input data fields if the data set includes many data fields) and different connection weights. Further, the models of the input set 1020 of the initial epoch may include nodes having different activation functions, aggregation functions, and/or bias values/functions.

During execution, the genetic algorithm 1010 performs fitness evaluation 1040 and evolutionary operations 1050 on the input set 1020. In this context, fitness evaluation 1040 includes evaluating each model of the input set 1020 using a fitness function 1042 to determine a fitness function value 1044 (“FF values” in FIG. 10) for each model of the input set 1020. The fitness function values 1044 are used to select one or more models of the input set 1020 to modify using one or more of the evolutionary operations 1050. In FIG. 10, the evolutionary operations 1050 include mutation operations 1052, crossover operations 1054, and extinction operations 1056, each of which is described further below.

During the fitness evaluation 1040, each model of the input set 1020 is tested based on the input data 1002 to determine a corresponding fitness function value 1044. For example, a first portion 1004 of the input data 1002 may be provided as input data to each model, which processes the input data (according to the network topology, connection weights, activation function, etc., of the respective model) to generate output data. The output data of each model is evaluated using the fitness function 1042 and the first portion 1004 of the input data 1002 to determine how well the model modeled the input data 1002. In some examples, fitness of a model is based on reliability of the model, performance of the model, complexity (or sparsity) of the model, size of the latent space, or a combination thereof.

In a particular aspect, fitness evaluation 1040 of the models of the input set 1020 is performed in parallel. To illustrate, the system 1000 may include devices, processors, cores, and/or threads 1080 in addition to those that execute the genetic algorithm 1010 and the optimization trainer 1060. These additional devices, processors, cores, and/or threads 1080 can perform the fitness evaluation 1040 of the models of the input set 1020 in parallel based on a first portion 1004 of the input data 1002 and may provide the resulting fitness function values 1044 to the genetic algorithm 1010.

The mutation operation 1052 and the crossover operation 1054 are highly stochastic under certain constraints and a defined set of probabilities optimized for model building, which produces reproduction operations that can be used to generate the output set 1030, or at least a portion thereof, from the input set 1020. In a particular implementation, the genetic algorithm 1010 utilizes intra-species reproduction (as opposed to inter-species reproduction) in generating the output set 1030. In other implementations, inter-species reproduction may be used in addition to or instead of intra-species reproduction to generate the output set 1030. Generally, the mutation operation 1052 and the crossover operation 1054 are selectively performed on models that are more fit (e.g., have higher fitness function values 1044, fitness function values 1044 that have changed significantly between two or more epochs, or both).

The extinction operation 1056 uses a stagnation criterion to determine when a species should be omitted from a population used as the input set 1020 for a subsequent epoch of the genetic algorithm 1010. Generally, the extinction operation 1056 is selectively performed on models that satisfy a stagnation criteria, such as models that have low fitness function values 1044, fitness function values 1044 that have changed little over several epochs, or both.

In accordance with the present disclosure, cooperative execution of the genetic algorithm 1010 and the optimization trainer 1060 is used arrive at a solution faster than would occur by using a genetic algorithm 1010 alone or an optimization trainer 1060 alone. Additionally, in some implementations, the genetic algorithm 1010 and the optimization trainer 1060 evaluate fitness using different data sets, with different measures of fitness, or both, which can improve fidelity of operation of the final model. To facilitate cooperative execution, a model (referred to herein as a trainable model 1032 in FIG. 10) is occasionally sent from the genetic algorithm 1010 to the optimization trainer 1060 for training. In a particular implementation, the trainable model 1032 is based on crossing over and/or mutating the fittest models (based on the fitness evaluation 1040) of the input set 1020. In such implementations, the trainable model 1032 is not merely a selected model of the input set 1020; rather, the trainable model 1032 represents a potential advancement with respect to the fittest models of the input set 1020.

The optimization trainer 1060 uses a second portion 1006 of the input data 1002 to train the connection weights and biases of the trainable model 1032, thereby generating a trained model 1062. The optimization trainer 1060 does not modify the architecture of the trainable model 1032.

During optimization, the optimization trainer 1060 provides a second portion 1006 of the input data 1002 to the trainable model 1032 to generate output data. The optimization trainer 1060 performs a second fitness evaluation 1070 by comparing the data input to the trainable model 1032 to the output data from the trainable model 1032 to determine a second fitness function value 1074 based on a second fitness function 1072. The second fitness function 1072 is the same as the first fitness function 1042 in some implementations and is different from the first fitness function 1042 in other implementations. In some implementations, the optimization trainer 1060 or portions thereof is executed on a different device, processor, core, and/or thread than the genetic algorithm 1010. In such implementations, the genetic algorithm 1010 can continue executing additional epoch(s) while the connection weights of the trainable model 1032 are being trained by the optimization trainer 1060. When training is complete, the trained model 1062 is input back into (a subsequent epoch of) the genetic algorithm 1010, so that the positively reinforced “genetic traits” of the trained model 1062 are available to be inherited by other models in the genetic algorithm 1010.

In implementations in which the genetic algorithm 1010 employs speciation, a species ID of each of the models may be set to a value corresponding to the species that the model has been clustered into. A species fitness may be determined for each of the species. The species fitness of a species may be a function of the fitness of one or more of the individual models in the species. As a simple illustrative example, the species fitness of a species may be the average of the fitness of the individual models in the species. As another example, the species fitness of a species may be equal to the fitness of the fittest or least fit individual model in the species. In alternative examples, other mathematical functions may be used to determine species fitness. The genetic algorithm 1010 may maintain a data structure that tracks the fitness of each species across multiple epochs. Based on the species fitness, the genetic algorithm 1010 may identify the “fittest” species, which may also be referred to as “elite species.” Different numbers of elite species may be identified in different embodiments.

In a particular aspect, the genetic algorithm 1010 uses species fitness to determine if a species has become stagnant and is therefore to become extinct. As an illustrative non-limiting example, the stagnation criterion of the extinction operation 1056 may indicate that a species has become stagnant if the fitness of that species remains within a particular range (e.g., +/−5%) for a particular number (e.g., 5) of epochs. If a species satisfies a stagnation criterion, the species and all underlying models may be removed from subsequent epochs of the genetic algorithm 1010.

In some implementations, the fittest models of each “elite species” may be identified. The fittest models overall may also be identified. An “overall elite” need not be an “elite member,” e.g., may come from a non-elite species. Different numbers of “elite members” per species and “overall elites” may be identified in different embodiments.”

The output set 1030 of the epoch is generated based on the input set 1020 and the evolutionary operation 1050. In the illustrated example, the output set 1030 includes the same number of models as the input set 1020. In some implementations, the output set 1030 includes each of the “overall elite” models and each of the “elite member” models. Propagating the “overall elite” and “elite member” models to the next epoch may preserve the “genetic traits” that resulted in such models being assigned high fitness values.

The rest of the output set 1030 may be filled out by random reproduction using the crossover operation 1054 and/or the mutation operation 1052. After the output set 1030 is generated, the output set 1030 may be provided as the input set 1020 for the next epoch of the genetic algorithm 1010.

After one or more epochs of the genetic algorithm 1010 and one or more rounds of optimization by the optimization trainer 1060, the system 1000 selects a particular model or a set of models as the final model (e.g., a model that is executable to perform one or more of the model-based operations of FIGS. 1-9). For example, the final model may be selected based on the fitness function values 1044, 1074. For example, a model or set of models having the highest fitness function value 1044 or 1074 may be selected as the final model. When multiple models are selected (e.g., an entire species is selected), an ensembler can be generated (e.g., based on heuristic rules or using the genetic algorithm 1010) to aggregate the multiple models. In some implementations, the final model can be provided to the optimization trainer 1060 for one or more rounds of optimization after the final model is selected. Subsequently, the final model can be output for use with respect to other data (e.g., real-time data).

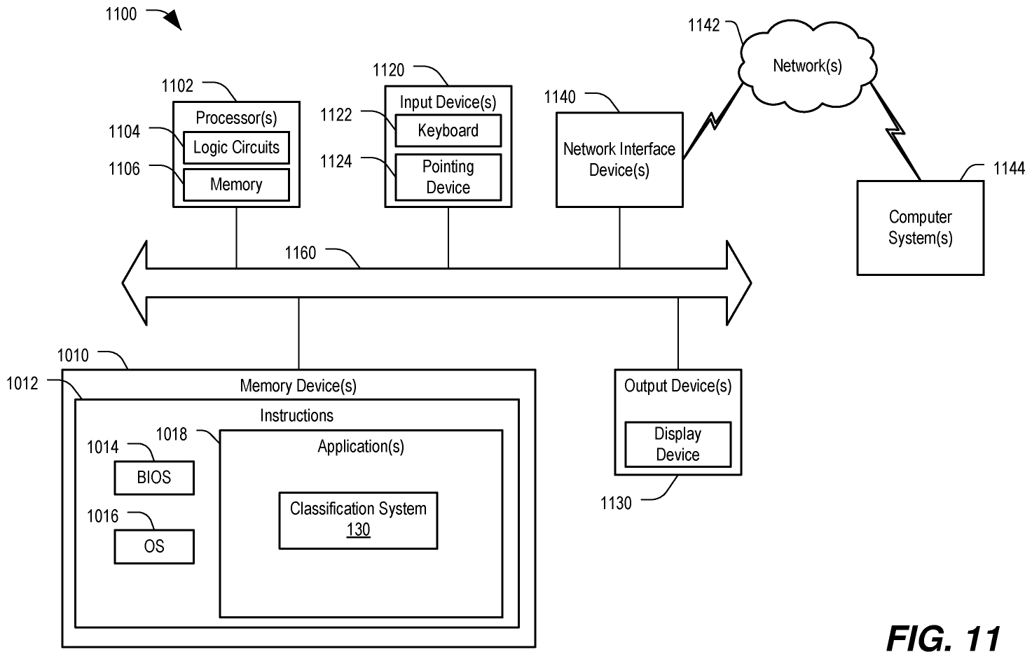

FIG. 11 is a block diagram of a particular computer system 1100 configured to initiate, perform, or control one or more of the operations described with reference to FIGS. 1-10. For example, the computer system 1100 may include, or be included within, one or more of the devices, wide area wireless networks, or servers described with reference to FIGS. 1-10. The computer system 1100 can also be implemented as or incorporated into one or more of various other devices, such as a personal computer (PC), a tablet PC, a server computer, a personal digital assistant (PDA), a laptop computer, a desktop computer, a communications device, a wireless telephone, or any other machine capable of executing a set of instructions (sequential or otherwise) that specify actions to be taken by that machine. In some examples, the computer system 1100, or at least components thereof, are included in a device that is associated with a battery or a cell, such as a vehicle, a device associated with a battery-based electrical grid, etc. Further, while a single computer system 1100 is illustrated, the term “system” includes any collection of systems or sub-systems that individually or jointly execute a set, or multiple sets, of instructions to perform one or more computer functions.

While FIG. 11 illustrates one example of the particular computer system 1100, other computer systems or computing architectures and configurations may be used for carrying out the operations disclosed herein. The computer system 1100 includes one or more processors 1102. Each processor of the one or more processors 1102 can include a single processing core or multiple processing cores that operate sequentially, in parallel, or sequentially at times and in parallel at other times. Each processor of the one or more processors 1102 includes circuitry defining a plurality of logic circuits 1104, working memory 1106 (e.g., registers and cache memory), communication circuits, etc., which together enable the processor to control the operations performed by the computer system 1100 and enable the processor to generate a useful result based on analysis of particular data and execution of specific instructions.

The processor(s) 1102 are configured to interact with other components or subsystems of the computer system 1100 via a bus 1160. The bus 1160 is illustrative of any interconnection scheme serving to link the subsystems of the computer system 1100, external subsystems or device, or any combination thereof. The bus 1160 includes a plurality of conductors to facilitate communication of electrical and/or electromagnetic signals between the components or subsystems of the computer system 1100. Additionally, the bus 1160 includes one or more bus controller or other circuits (e.g., transmitters and receivers) that manage signaling via the plurality of conductors and that cause signals sent via the plurality of conductors to conform to particular communication protocols.

The computer system 1100 also includes one or more memory devices 1110. The memory devices 1110 include any suitable computer-readable storage device depending on, for example, whether data access needs to be bi-directional or unidirectional, speed of data access required, memory capacity required, other factors related to data access, or any combination thereof. Generally, the memory devices 1110 include some combination of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain type of RAM, such as resistive random-access memory (ReRAM). Other examples of both volatile and non-volatile memory devices can be used as well, or in the alternative, so long as such memory devices store information in a physical, tangible medium. Thus, the memory devices 1110 include circuits and structures and are not merely signals or other transitory phenomena.

The memory device(s) 1110 store instructions 1112 that are executable by the processor(s) 1102 to perform various operations and functions. The instructions 1112 include instructions to enable the various components and subsystems of the computer system 1100 to operate, interact with one another, and interact with a user, such as an input/output system (BIOS) 1114 and an operating system (OS) 1116. Additionally, the instructions 1112 include one or more applications 1118, scripts, or other program code to enable the processor(s) 1102 to perform the operations described herein. For example, the instructions 1112 can include the classification system 130 of FIG. 1.

In FIG. 11, the computer system 1100 also includes one or more output devices 1130, one or more input devices 1120, and one or more network interface devices 1140. Each of the output device(s) 1130, the input device(s) 1120, and the network interface device(s) 1140 can be coupled to the bus 1160 via a port or connector, such as a Universal Serial Bus port, a digital visual interface (DVI) port, a serial ATA (SATA) port, a small computer system interface (SCSI) port, a high-definition media interface (HDMI) port, or another serial or parallel port. In some implementations, one or more of the output device(s) 1130, the input device(s) 1120, the network interface device(s) 1140 is coupled to or integrated within a housing with the processor(s) 1102 and the memory devices 1110, in which case the connections to the bus 1160 can be internal, such as via an expansion slot or other card-to-card connector. In other implementations, the processor(s) 1102 and the memory devices 1110 are integrated within a housing that includes one or more external ports, and one or more of the output device(s) 1130, the input device(s) 1120, the network interface device(s) 1140 is coupled to the bus 1160 via the external port(s).

Examples of the output device(s) 1130 include a display device, one or more speakers, a printer, a television, a projector, or another device to provide an output of data in a manner that is perceptible by a user. Examples of the input device(s) 1120 include buttons, switches, knobs, a keyboard 1122, a pointing device 1124, a biometric device, a microphone, a motion sensor, or another device to detect user input actions. The pointing device 1124 includes, for example, one or more of a mouse, a stylus, a track ball, a pen, a touch pad, a touch screen, a tablet, another device that is useful for interacting with a graphical user interface, or any combination thereof.

The network interface device(s) 1140 is configured to enable the computer system 1100 to communicate with one or more other computer systems 1144 via one or more networks 1142. The network interface device(s) 1140 encode data in electrical and/or electromagnetic signals that are transmitted to the other computer system(s) 1144 using pre-defined communication protocols. The electrical and/or electromagnetic signals can be transmitted wirelessly (e.g., via propagation through free space), via one or more wires, cables, optical fibers, or via a combination of wired and wireless transmission.

In an alternative embodiment, dedicated hardware implementations, such as application specific integrated circuits, programmable logic arrays and other hardware devices, can be constructed to implement one or more of the operations described herein. Accordingly, the present disclosure encompasses software, firmware, and hardware implementations.

It is to be understood that the division and ordering of steps described herein is for illustrative purposes only and is not considered limiting. In alternative implementations, certain steps may be combined and other steps may be subdivided into multiple steps. Moreover, the ordering of steps may change.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based (e.g., cloud computing) embodiment, an entirely hardware embodiment, or an embodiment combining aspects of the internet, software and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Clause 1 includes a method including: obtaining data representative of a state or condition of an evaluation target; providing first input based on the data to a trained classifier to generate a first result; providing second input based on the data to adaptive neuro-fuzzy inference system to generate a second result; and assigning a classification to the state or condition of the evaluation target based on the first result and the second result.

Clause 2 includes the method of Clause 1, wherein the trained classifier corresponds to or includes a neural network.

Clause 3 includes the method of any of Clauses 1 to 2, wherein the trained classifier corresponds to or includes one or more of a perceptron, a decision tree, a random forest, a Bayesian network, a logistic regression classifier, or a support vector machine.

Clause 4 includes the method of any of Clauses 1 to 3, wherein the second input includes the first result.

Clause 5 includes the method of any of Clauses 1 to 3, wherein the first input includes the second result.

Clause 6 includes the method of any of Clauses 1 to 5, further including determining a joint result based on the first result and the second result, wherein the classification is assigned based on the joint result.

Clause 7 includes the method of Clause 6, wherein determining the joint result includes determining a product or sum of values of the first result and the second result.

Clause 8 includes the method of Clause 6, wherein determining the joint result includes determining, based on values of the first result and the second result, a floor value or a ceiling value.

Clause 9 includes the method of Clause 6, wherein determining the joint result includes applying one or more Boolean operations to values of the first result and the second result.

Clause 10 includes the method of Clause 6, wherein the second result represents outputs of a consequent layer of the adaptive neuro-fuzzy inference system and determining the joint result includes combining a value of the first result with the outputs of the consequent layer at an output layer of the adaptive neuro-fuzzy inference system.

Clause 11 includes the method of any of Clauses 1 to 6, wherein the adaptive neuro-fuzzy inference system generates the second result based on a subset of rules of a plurality of rules, and further including selecting the subset of rules from among the plurality of rules based on the first result.

Clause 12 includes the method of any of Clauses 1 to 11, wherein the adaptive neuro-fuzzy inference system generates the second result based on one or more membership functions, and further including determining parameters of the one or more membership functions based on the first result.

Clause 13 includes the method of any of Clauses 1 to 12, further including selecting the adaptive neuro-fuzzy inference system from among a plurality of adaptive neuro-fuzzy inference systems based on the first result.

Clause 14 includes the method of any of Clauses 1 to 13, further including selecting the trained classifier from among a plurality of trained classifiers based on the second result.

Clause 15 includes the method of any of Clauses 1 to 14, wherein the first input includes particular values selected from the data and the second input includes the particular values selected from the data.

Clause 16 includes the method of any of Clauses 1 to 15, wherein the first input includes values of a first set of variables selected from the data and the second input includes values of a second set of variables selected from the data, where the first set of variables is distinct from the second set of variables.

Clause 17 includes the method of any of Clauses 1 to 16, wherein the data includes sensor data from a plurality of sensor associated with the evaluation target.

Clause 18 includes the method of any of Clauses 1 to 17, wherein the evaluation target includes one or more electronic devices, one or more electromechanical devices, one or more pneumatic devices, one or more hydraulic devices, one or more mechanical devices, one or more radiologic devices, or a combination thereof.

Clause 19 includes the method of any of Clauses 1 to 18, wherein the data includes sensor data from a downhole sensor system, the evaluation target includes a bore hole, and the classification identifies a geological structure associated with the bore hole.

Clause 20 includes the method of any of Clauses 1 to 19, further including generating a graphical user interface indicating the classification.

Clause 21 includes the method of Clause 20, wherein the graphical user interface further indicates the first result, the second result, or both.

Clause 22 includes the method of Clause 20, wherein the graphical user interface includes a representation of a dominant rule used by the adaptive neuro-fuzzy inference system to generate the second result.

Clause 23 includes the method of any of Clauses 1 to 22, further including generating a graphical user interface including representations of rules used by the adaptive neuro-fuzzy inference system to generate the second result.

Clause 24 includes the method of Clause 23, further including receiving input indicating a modification of one or more of the rules and modifying one or more parameters of the adaptive neuro-fuzzy inference system based on the input.

Clause 25 includes the method of Clause 23, wherein the representations of the rules include a graphical representation of at least one membership function used by the of the adaptive neuro-fuzzy inference system.

Clause 26 includes the method of any of Clauses 1 to 25, wherein the data representative of the state or condition of the evaluation target includes annotated time series data including annotations indicating time series segments and one or more labels, each label of the one or more labels associated with a corresponding time series segment of the one or more time series segments.

Clause 27 includes the method of Clause 26, wherein the first input includes first time series data of one of the time series segments, and further including: determining an error based on a difference between the first result and an annotation associated with the first time series data; and modifying a parameter of the trained classifier based on the error.

Clause 28 includes the method of Clause 27, wherein the parameter includes a link weight.

Clause 29 includes the method of Clause 26, wherein the second input includes first time series data of one of the time series segments, and further including: determining an error based on a difference between the second result and an annotation associated with the first time series data; and modifying a parameter of the adaptive neuro-fuzzy inference system based on the error.

Clause 30 includes the method of Clause 29, wherein the parameter includes a parameter of a membership function.

Clause 31 includes the method of Clause 29, wherein the parameter includes a logical connector of two or more premises.

Clause 32 includes the method of Clause 29, wherein the parameter includes a consequent layer parameter.

Clause 33 includes a device including: one or more processors; and one or more memory devices accessible to the one or more processors, the one or more memory devices storing instructions that are executable by the one or more processors to cause the one or more processors to: obtain data representative of a state or condition of an evaluation target; provide first input based on the data to a trained classifier to generate a first result; provide second input based on the data to adaptive neuro-fuzzy inference system to generate a second result; and assign a classification to the state or condition of the evaluation target based on the first result and the second result.

Clause 34 includes the device of Clause 33, wherein the trained classifier corresponds to or includes a neural network.

Clause 35 includes the device of any of Clauses 33 to 34, wherein the trained classifier corresponds to or includes one or more of a perceptron, a decision tree, a random forest, a Bayesian network, a logistic regression classifier, or a support vector machine.

Clause 36 includes the device of any of Clauses 33 to 35, wherein the second input includes the first result.

Clause 37 includes the device of any of Clauses 33 to 35, wherein the first input includes the second result.

Clause 38 includes the device of any of Clauses 33 to 37, wherein the instructions further cause the one or more processors to determine a joint result based on the first result and the second result, and wherein the classification is assigned based on the joint result.

Clause 39 includes the device of Clause 38, wherein determining the joint result includes determining a product or sum of values of the first result and the second result.

Clause 40 includes the device of Clause 38, wherein determining the joint result includes determining, based on values of the first result and the second result, a floor value or a ceiling value.

Clause 41 includes the device of Clause 38, wherein determining the joint result includes applying one or more Boolean operations to values of the first result and the second result.

Clause 42 includes the device of Clause 38, wherein the second result represents outputs of a consequent layer of the adaptive neuro-fuzzy inference system and determining the joint result includes combining a value of the first result with the outputs of the consequent layer at an output layer of the adaptive neuro-fuzzy inference system.

Clause 43 includes the device of any of Clauses 33 to 42, wherein the adaptive neuro-fuzzy inference system generates the second result based on a subset of rules of a plurality of rules, and wherein the instructions further cause the one or more processors to select the subset of rules from among the plurality of rules based on the first result.

Clause 44 includes the device of any of Clauses 33 to 43, wherein the adaptive neuro-fuzzy inference system generates the second result based on one or more membership functions, and wherein the instructions further cause the one or more processors to determine parameters of the one or more membership functions based on the first result.

Clause 45 includes the device of any of Clauses 33 to 44, wherein the instructions further cause the one or more processors to select the adaptive neuro-fuzzy inference system from among a plurality of adaptive neuro-fuzzy inference systems based on the first result.

Clause 46 includes the device of any of Clauses 33 to 45, wherein the instructions further cause the one or more processors to select the trained classifier from among a plurality of trained classifiers based on the second result.

Clause 47 includes the device of any of Clause 33 to 46, wherein the first input includes particular values selected from the data and the second input includes the particular values selected from the data.

Clause 48 includes the device of any of Clauses 33 to 47, wherein the first input includes values of a first set of variables selected from the data and the second input includes values of a second set of variables selected from the data, where the first set of variables is distinct from the second set of variables.

Clause 49 includes the device of any of Clauses 33 to 48, wherein the data includes sensor data from a plurality of sensors associated with the evaluation target.

Clause 50 includes the device of any of Clauses 33 to 49, wherein the evaluation target includes one or more electronic devices, one or more electromechanical devices, one or more pneumatic devices, one or more hydraulic devices, one or more mechanical devices, one or more radiologic devices, or a combination thereof.

Clause 51 includes the device of any of Clauses 33 to 50, wherein the data includes sensor data from a downhole sensor system, the evaluation target includes a bore hole, and the classification identifies a geological structure associated with the bore hole.

Clause 52 includes the device of any of Clauses 33 to 51, wherein the instructions further cause the one or more processors to generate a graphical user interface indicating the classification.

Clause 53 includes the device of Clause 52, wherein the graphical user interface further indicates the first result, the second result, or both.

Clause 54 includes the device of Clause 52, wherein the graphical user interface includes a representation of a dominant rule used by the adaptive neuro-fuzzy inference system to generate the second result.

Clause 55 includes the device of any of Clauses 33 to 54, wherein the instructions further cause the one or more processors to generate a graphical user interface including representations of rules used by the adaptive neuro-fuzzy inference system to generate the second result.

Clause 56 includes the device of Clause 55, wherein the instructions further cause the one or more processors to receive input indicating a modification of one or more of the rules and modifying one or more parameters of the adaptive neuro-fuzzy inference system based on the input.

Clause 57 includes the device of Clause 55, wherein the representations of the rules include a graphical representation of at least one membership function used by the adaptive neuro-fuzzy inference system.

Clause 58 includes the device of any of Clauses 33 to 57, wherein the data representative of the state or condition of the evaluation target includes annotated time series data including annotations indicating time series segments and one or more labels, each label of the one or more labels associated with a corresponding time series segment of the one or more time series segments.

Clause 59 includes the device of Clause 58, wherein the first input includes first time series data of one of the time series segments, and wherein the instructions further cause the one or more processors to: determine an error based on a difference between the first result and an annotation associated with the first time series data; and modify a parameter of the trained classifier based on the error.

Clause 60 includes the device of Clause 59, wherein the parameter includes a link weight.

Clause 61 includes the device of Clause 58, wherein the second input includes first time series data of one of the time series segments, and wherein the instructions further cause the one or more processors to: determine an error based on a difference between the second result and an annotation associated with the first time series data; and modify a parameter of the adaptive neuro-fuzzy inference system based on the error.

Clause 62 includes the device of Clause 61, wherein the parameter includes a parameter of a membership function.

Clause 63 includes the device of Clause 61, wherein the parameter includes a logical connector of two or more premises.

Clause 64 includes the device of Clause 61, wherein the parameter includes a consequent layer parameter.

Clause 65 includes a computer-readable storage device storing instructions that are executable by one or more processors to perform operations including: obtaining data representative of a state or condition of an evaluation target; providing first input based on the data to a trained classifier to generate a first result; providing second input based on the data to adaptive neuro-fuzzy inference system to generate a second result; and assigning a classification to the state or condition of the evaluation target based on the first result and the second result.

Clause 66 includes the computer-readable storage device of Clause 65, wherein the trained classifier corresponds to or includes a neural network.

Clause 67 includes the computer-readable storage device of any of Clauses 65 to 66, wherein the trained classifier corresponds to or includes one or more of a perceptron, a decision tree, a random forest, a Bayesian network, a logistic regression classifier, or a support vector machine.

Clause 68 includes the computer-readable storage device of any of Clauses 65 to 67, wherein the second input includes the first result.

Clause 69 includes the computer-readable storage device of any of Clauses 65 to 67, wherein the first input includes the second result.

Clause 70 includes the computer-readable storage device of any of Clauses 65 to 69, wherein the operations further include determining a joint result based on the first result and the second result, and wherein the classification is assigned based on the joint result.

Clause 71 includes the computer-readable storage device of Clause 70, wherein determining the joint result includes determining a product or sum of values of the first result and the second result.

Clause 72 includes the computer-readable storage device of Clause 70, wherein determining the joint result includes determining, based on values of the first result and the second result, a floor value or a ceiling value.

Clause 73 includes the computer-readable storage device of Clause 70, wherein determining the joint result includes applying one or more Boolean operations to values of the first result and the second result.

Clause 74 includes the computer-readable storage device of Clause 70, wherein the second result represents outputs of a consequent layer of the adaptive neuro-fuzzy inference system and determining the joint result includes combining a value of the first result with the outputs of the consequent layer at an output layer of the adaptive neuro-fuzzy inference system.

Clause 75 includes the computer-readable storage device of any of Clauses 65 to 74, wherein the adaptive neuro-fuzzy inference system generates the second result based on a subset of rules of a plurality of rules, and wherein the operations further include selecting the subset of rules from among the plurality of rules based on the first result.

Clause 76 includes the computer-readable storage device of any of Clauses 65 to 75, wherein the adaptive neuro-fuzzy inference system generates the second result based on one or more membership functions, and wherein the operations further include determining parameters of the one or more membership functions based on the first result.

Clause 77 includes the computer-readable storage device of any of Clauses 65 to 76, wherein the operations further include selecting the adaptive neuro-fuzzy inference system from among a plurality of adaptive neuro-fuzzy inference systems based on the first result.

Clause 78 includes the computer-readable storage device of any of Clauses 65 to 77, wherein the operations further include selecting the trained classifier from among a plurality of trained classifiers based on the second result.

Clause 79 includes the computer-readable storage device of any of Clauses 65 to 78, wherein the first input includes particular values selected from the data and the second input includes the particular values selected from the data.

Clause 80 includes the computer-readable storage device of any of Clause 65 to 79, wherein the first input includes values of a first set of variables selected from the data and the second input includes values of a second set of variables selected from the data, where the first set of variables is distinct from the second set of variables.

Clause 81 includes the computer-readable storage device of any of Clauses 65 to 80, wherein the data includes sensor data from a plurality of sensor associated with the evaluation target.

Clause 82 includes the computer-readable storage device of any of Clauses 65 to 81, wherein the evaluation target includes one or more electronic devices, one or more electromechanical devices, one or more pneumatic devices, one or more hydraulic devices, one or more mechanical devices, one or more radiologic devices, or a combination thereof.

Clause 83 includes the computer-readable storage device of any of Clauses 65 to 82, wherein the data includes sensor data from a downhole sensor system, the evaluation target includes a bore hole, and the classification identifies a geological structure associated with the bore hole.

Clause 84 includes the computer-readable storage device of any of Clauses 65 to 83, wherein the operations further include generating a graphical user interface indicating the classification.

Clause 85 includes the computer-readable storage device of Clause 84, wherein the graphical user interface further indicates the first result, the second result, or both.

Clause 86 includes the computer-readable storage device of Clause 84, wherein the graphical user interface includes a representation of a dominant rule used by the adaptive neuro-fuzzy inference system to generate the second result.

Clause 87 includes the computer-readable storage device of any of Clauses 65 to 86, wherein the operations further include generating a graphical user interface including representations of rules used by the adaptive neuro-fuzzy inference system to generate the second result.

Clause 88 includes the computer-readable storage device of Clause 87, wherein the operations further include receiving input indicating a modification of one or more of the rules and modifying one or more parameters of the adaptive neuro-fuzzy inference system based on the input.

Clause 89 includes the computer-readable storage device of Clause 87, wherein the representations of the rules include a graphical representation of at least one membership function used by the of the adaptive neuro-fuzzy inference system.

Clause 90 includes the computer-readable storage device of any of Clauses 65 to 89, wherein the data representative of the state or condition of the evaluation target includes annotated time series data including annotations indicating time series segments and one or more labels, each label of the one or more labels associated with a corresponding time series segment of the one or more time series segments.

Clause 91 includes the computer-readable storage device of Clause 90, wherein the first input includes first time series data of one of the time series segments, and wherein the operations further include: determining an error based on a difference between the first result and an annotation associated with the first time series data; and modifying a parameter of the trained classifier based on the error.

Clause 92 includes the computer-readable storage device of Clause 91, wherein the parameter includes a link weight.

Clause 93 includes the computer-readable storage device of Clause 90, wherein the second input includes first time series data of one of the time series segments, and wherein the operations further include: determining an error based on a difference between the second result and an annotation associated with the first time series data; and modifying a parameter of the adaptive neuro-fuzzy inference system based on the error.

Clause 94 includes the computer-readable storage device of Clause 93, wherein the parameter includes a parameter of a membership function.

Clause 95 includes the computer-readable storage device of Clause 93, wherein the parameter includes a logical connector of two or more premises.

Clause 96 includes the computer-readable storage device of Clause 93, wherein the parameter includes a consequent layer parameter.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

Changes and modifications may be made to the disclosed embodiments without departing from the scope of the present disclosure. These and other changes or modifications are intended to be included within the scope of the present disclosure, as expressed in the following claims.

What is claimed is:

1. A method comprising:
obtaining data representative of a state or condition of an evaluation target;
providing first input based on the data to a trained classifier to generate a first result;
providing second input based on the data to an adaptive neuro-fuzzy inference system to generate a second result; and
assigning a classification to the state or condition of the evaluation target based on the first result and the second result.

2. The method of claim 1, wherein the trained classifier corresponds to or includes a neural network.

3. The method of claim 1, wherein the trained classifier corresponds to or includes one or more of a perceptron, a decision tree, a random forest, a Bayesian network, a logistic regression classifier, or a support vector machine.

4. The method of claim 1, wherein the second input includes the first result.

5. The method of claim 1, wherein the first input includes the second result.

6. The method of claim 1, further comprising determining a joint result based on the first result and the second result, wherein the classification is assigned based on the joint result.

7. The method of claim 6, wherein determining the joint result includes determining a product or sum of values of the first result and the second result.

8. The method of claim 6, wherein determining the joint result includes determining, based on values of the first result and the second result, a floor value or a ceiling value.

9. The method of claim 6, wherein determining the joint result includes applying one or more Boolean operations to values of the first result and the second result.

10. The method of claim 6, wherein the second result represents outputs of a consequent layer of the adaptive neuro-fuzzy inference system and determining the joint result includes combining a value of the first result with the outputs of the consequent layer at an output layer of the adaptive neuro-fuzzy inference system.

11. The method of claim 1, wherein the adaptive neuro-fuzzy inference system generates the second result based on a subset of rules of a plurality of rules, and further comprising selecting the subset of rules from among the plurality of rules based on the first result.

12. The method of claim 1, wherein the adaptive neuro-fuzzy inference system generates the second result based on one or more membership functions, and further comprising determining parameters of the one or more membership functions based on the first result.

13. The method of claim 1, further comprising selecting the adaptive neuro-fuzzy inference system from among a plurality of adaptive neuro-fuzzy inference systems based on the first result.

14. The method of claim 1, further comprising selecting the trained classifier from among a plurality of trained classifiers based on the second result.

15. The method of claim 1, wherein the first input includes particular values selected from the data and the second input includes the particular values selected from the data.

16. The method of claim 1, wherein the first input includes values of a first set of variables selected from the data and the second input includes values of a second set of variables selected from the data, where the first set of variables is distinct from the second set of variables.

17. The method of claim 1, wherein the data includes sensor data from a plurality of sensors associated with the evaluation target.

18. A device comprising:
one or more processors; and
one or more memory devices accessible to the one or more processors, the one or more memory devices storing instructions that are executable by the one or more processors to cause the one or more processors to:
obtain data representative of a state or condition of an evaluation target;
provide first input based on the data to a trained classifier to generate a first result;
provide second input based on the data to an adaptive neuro-fuzzy inference system to generate a second result; and
assign a classification to the state or condition of the evaluation target based on the first result and the second result.

19. The device of claim 18, wherein the evaluation target includes one or more electronic devices, one or more electromechanical devices, one or more pneumatic devices, one or more hydraulic devices, one or more mechanical devices, one or more radiologic devices, or a combination thereof.

20. The device of claim 18, wherein the data includes sensor data from a downhole sensor system, the evaluation target includes a bore hole, and the classification identifies a geological structure associated with the bore hole.

21. The device of claim 18, wherein the instructions further cause the one or more processors to generate a graphical user interface indicating the classification.

22. The device of claim 21, wherein the graphical user interface further indicates the first result, the second result, or both.

23. The device of claim 21, wherein the graphical user interface includes a representation of a dominant rule used by the adaptive neuro-fuzzy inference system to generate the second result.

24. The device of claim 18, wherein the instructions further cause the one or more processors to generate a graphical user interface including representations of rules used by the adaptive neuro-fuzzy inference system to generate the second result.

25. The device of claim 24, wherein the instructions further cause the one or more processors to receive input indicating a modification of one or more of the rules and modifying one or more parameters of the adaptive neuro-fuzzy inference system based on the input.

26. The device of claim 24, wherein the representations of the rules include a graphical representation of at least one membership function used by the of the adaptive neuro-fuzzy inference system.

27. A computer-readable storage device storing instructions that are executable by one or more processors to perform operations comprising:
obtaining data representative of a state or condition of an evaluation target;
providing first input based on the data to a trained classifier to generate a first result;
providing second input based on the data to an adaptive neuro-fuzzy inference system to generate a second result; and
assigning a classification to the state or condition of the evaluation target based on the first result and the second result.

28. The computer-readable storage device of claim 27, wherein the data representative of the state or condition of the evaluation target comprises annotated time series data including annotations indicating time series segments and one or more labels, each label of the one or more labels associated with a corresponding time series segment of the one or more time series segments.

29. The computer-readable storage device of claim 28, wherein the first input includes first time series data of one of the time series segments, and wherein the operations further comprise:
determining an error based on a difference between the first result and an annotation associated with the first time series data; and
modifying a parameter of the trained classifier based on the error.

30. The computer-readable storage device of claim 29, wherein the parameter includes a link weight.
